(19) United States
(12) Patent Application Publication
(10) Pub. No.: US 2026/0205250 A1
(43) Pub. Date: Jul. 16, 2026

(54) TRANSMISSION CONFIGURATION INDICATOR STATE MANAGEMENT FOR VIRTUAL CELLS

(71) Applicant: QUALCOMM Incorporated, San Diego, CA (US)

(72) Inventors: Kiran VENUGOPAL, Green Brook, NJ (US); Yan ZHOU, San Diego, CA (US); Kianoush HOSSEINI, San Diego, CA (US)

(21) Appl. No.: 19/016,310

(22) Filed: Jan. 10, 2025

(51) Int. Cl. H04L 5/00; H04L 5/14

(52) U.S. Cl. CPC H04L 5/0092; H04L 5/001; H04L 5/14

(57) ABSTRACT

Methods, systems, and devices for wireless communications are described. A user equipment (UE) may receive a first indication of a reference signal configuration for a virtual cell that includes a set of multiple sub-bands. The reference signal configuration may indicate whether a reference signal associated with a transmission configuration indicator (TCI) state is included in one sub-band of the set of sub-bands or in two or more sub-bands of the set of sub-bands. The UE may receive a second indication of one or more parameters for the TCI state, and the parameters may be applicable to one or more sub-bands of the set of sub-bands. The UE may communicate one or more messages via a first sub-band of the plurality of sub-bands of the virtual cell based on receiving the reference signal and in accordance with the one or more parameters.

### FIELD OF TECHNOLOGY

The following relates to wireless communications, including transmission configuration indicator state management for virtual cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, receiving a second indication of one or more parameters for the transmission configuration indicator state, where the one or more parameters are applicable to one or more sub-bands of the set of multiple sub-bands, and communicating one or more messages via a first sub-band of the set of multiple sub-bands of the virtual cell based on receiving the reference signal and in accordance with the one or more parameters.

A UE for wireless communications is described. The UE may include one or more memories storing processor executable code, and one or more processors coupled with the one or more memories. The one or more processors may individually or collectively be operable to execute the code to cause the UE to receive a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, receive a second indication of one or more parameters for the transmission configuration indicator state, where the one or more parameters are applicable to one or more sub-bands of the set of multiple sub-bands, and communicate one or more messages via a first sub-band of the set of multiple sub-bands of the virtual cell based on receiving the reference signal and in accordance with the one or more parameters.

Another UE for wireless communications is described. The UE may include means for receiving a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, means for receiving a second indication of one or more parameters for the transmission configuration indicator state, where the one or more parameters are applicable to one or more sub-bands of the set of multiple sub-bands, and means for communicating one or more messages via a first sub-band of the set of multiple sub-bands of the virtual cell based on receiving the reference signal and in accordance with the one or more parameters.

A non-transitory computer-readable medium storing code for wireless communications is described. The code may include instructions executable by one or more processors to receive a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, receive a second indication of one or more parameters for the transmission configuration indicator state, where the one or more parameters are applicable to one or more sub-bands of the set of multiple sub-bands, and communicate one or more messages via a first sub-band of the set of multiple sub-bands of the virtual cell based on receiving the reference signal and in accordance with the one or more parameters.

In some examples of the method, UEs, and non-transitory computer-readable medium described herein, the reference signal may be located across the two or more sub-bands and the two or more sub-bands include each sub-band of the set of multiple sub-bands that may be associated with the transmission configuration indicator state.

In some examples of the method, UEs, and non-transitory computer-readable medium described herein, the reference signal may be included in the two or more sub-bands, a first set of sub-bands of the set of multiple sub-bands including the first sub-band may be associated with the transmission configuration indicator state, and the two or more sub-bands include a subgroup of sub-bands of the first set of sub-bands.

Some examples of the method, UEs, and non-transitory computer-readable medium described herein may further include operations, features, means, or instructions for receiving a third indication of one or more second parameters for a second transmission configuration indicator state different than the transmission configuration indicator state, where the one or more second parameters may be applicable to one or more second sub-bands of the set of multiple sub-bands and communicating one or more second messages via a second sub-band of the set of multiple sub-bands of the virtual cell in accordance with the second transmission configuration indicator state.

Some examples of the method, UEs, and non-transitory computer-readable medium described herein may further include operations, features, means, or instructions for receiving a fourth indication of a first sub-band configuration for the first sub-band, the first sub-band configuration indicating a reference sub-band, a reference bandwidth part, a reference component carrier, or any combination thereof that includes the one or more parameters, where communicating the one or more messages via the first sub-band may be based on receiving the fourth indication and receiving a fifth indication of a second sub-band configuration for the second sub-band, the second sub-band configuration indicating a reference sub-band, a reference bandwidth part, a reference component carrier, or any combination thereof that includes the one or more second parameters, where communicating the one or more second messages via the second sub-band may be based on receiving the fifth indication.

Some examples of the method, UEs, and non-transitory computer-readable medium described herein may further include operations, features, means, or instructions for receiving a list of sub-bands that utilize the one or more parameters, where communicating the one or more messages via the first sub-band may be based on the first sub-band being included in the list of sub-bands.

Some examples of the method, UEs, and non-transitory computer-readable medium described herein may further include operations, features, means, or instructions for receiving a control message that modifies the one or more parameters, the one or more second parameters, or both, where, after modification, the one or more parameters may be applied to each of the one or more sub-bands and the one or more second parameters may be applied to each of the one or more second sub-bands.

Some examples of the method, UEs, and non-transitory computer-readable medium described herein may further include operations, features, means, or instructions for receiving a control message that modifies the one or more parameters, the one or more second parameters, or both, where the control message includes one or more identifiers for respective sub-bands to which the one or more parameters or the one or more second parameters may be applicable after modification.

Some examples of the method, UEs, and non-transitory computer-readable medium described herein may further include operations, features, means, or instructions for receiving the reference signal in accordance with the reference signal configuration, where a first parameter of the one or more parameters may be derived at least in part from the reference signal configuration and receiving a second reference signal associated with the transmission configuration indicator state in accordance with the reference signal configuration, where a second parameter of the one or more parameters may be derived at least in part from the reference signal configuration.

In some examples of the method, UEs, and non-transitory computer-readable medium described herein, the first parameter may be derived at least in part from a first reference signal identifier for the reference signal and the second parameter may be derived at least in part from a second reference signal identifier for the second reference signal, a sub-band that includes the second reference signal, or both.

In some examples of the method, UEs, and non-transitory computer-readable medium described herein, receiving the second indication may include operations, features, means, or instructions for receiving an indication of a virtual transmission configuration indicator state associated with a set of multiple transmission configuration indicator states including the transmission configuration indicator state, where the one or more parameters may be based on a mapping between the virtual transmission configuration indicator state and the transmission configuration indicator state.

Some examples of the method, UEs, and non-transitory computer-readable medium described herein may further include operations, features, means, or instructions for receiving a third indication of the mapping between the virtual transmission configuration indicator state and the transmission configuration indicator state.

In some examples of the method, UEs, and non-transitory computer-readable medium described herein, the mapping between the virtual transmission configuration indicator state and the transmission configuration indicator state may be based on an identifier of the virtual cell and an identifier of the transmission configuration indicator state.

Some examples of the method, UEs, and non-transitory computer-readable medium described herein may further include operations, features, means, or instructions for receiving a control message that modifies one or more transmission configuration indicator parameters for a set of multiple transmission configuration indicator states associated with the set of multiple sub-bands, where communicating the one or more messages may be based on receiving the control message.

In some examples of the method, UEs, and non-transitory computer-readable medium described herein, the one or more parameters include a first quasi co-location type for the transmission configuration indicator state and a second quasi co-location type for the transmission configuration indicator state and the first quasi co-location type may be associated with a spatial parameter and the second quasi co-location type may be associated with a Doppler shift, a Doppler spread, an average delay, a delay spread, or any combination thereof.

In some examples of the method, UEs, and non-transitory computer-readable medium described herein, the first sub-band may be non-contiguous with at least a second sub-band of the set of multiple sub-bands in a frequency domain.

A method for wireless communications by a network entity is described. The method may include outputting a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, outputting a second indication of one or more parameters for the transmission configuration indicator state, where the one or more parameters are applicable to one or more sub-bands of the set of multiple sub-bands, and communicating one or more messages via a first sub-band of the set of multiple sub-bands of the virtual cell based on receiving the reference signal and in accordance with the one or more parameters.

A network entity for wireless communications is described. The network entity may include one or more memories storing processor executable code, and one or more processors coupled with the one or more memories. The one or more processors may individually or collectively be operable to execute the code to cause the network entity to output a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, output a second indication of one or more parameters for the transmission configuration indicator state, where the one or more parameters are applicable to one or more sub-bands of the set of multiple sub-bands, and communicate one or more messages via a first sub-band of the set of multiple sub-bands of the virtual cell based on receiving the reference signal and in accordance with the one or more parameters.

Another network entity for wireless communications is described. The network entity may include means for outputting a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, means for outputting a second indication of one or more parameters for the transmission configuration indicator state, where the one or more parameters are applicable to one or more sub-bands of the set of multiple sub-bands, and means for communicating one or more messages via a first sub-band of the set of multiple sub-bands of the virtual cell based on receiving the reference signal and in accordance with the one or more parameters.

A non-transitory computer-readable medium storing code for wireless communications is described. The code may include instructions executable by one or more processors to output a first indication of a reference signal configuration for a virtual cell that includes a set of multiple sub-bands, where the reference signal configuration indicates whether a reference signal associated with a transmission configuration indicator state is included in one sub-band of the set of multiple sub-bands or in two or more sub-bands of the set of multiple sub-bands, output a second indication of one or more parameters for the transmission configuration indicator state, where the one or more parameters are applicable to one or more sub-bands of the set of multiple sub-bands, and communicate one or more messages via a first sub-band of the set of multiple sub-bands of the virtual cell based on receiving the reference signal and in accordance with the one or more parameters.

In some examples of the method, network entities, and non-transitory computer-readable medium described herein, the reference signal may be located across the two or more sub-bands and the two or more sub-bands include each sub-band of the set of multiple sub-bands that may be associated with the transmission configuration indicator state.

In some examples of the method, network entities, and non-transitory computer-readable medium described herein, the reference signal may be included in the two or more sub-bands, a first set of sub-bands of the set of multiple sub-bands including the first sub-band may be associated with the transmission configuration indicator state, and the two or more sub-bands include a subgroup of sub-bands of the first set of sub-bands.

Some examples of the method, network entities, and non-transitory computer-readable medium described herein may further include operations, features, means, or instructions for outputting a third indication of one or more second parameters for a second transmission configuration indicator state different than the transmission configuration indicator state, where the one or more second parameters may be applicable to one or more second sub-bands of the set of multiple sub-bands and communicating one or more second messages via a second sub-band of the set of multiple sub-bands of the virtual cell in accordance with the second transmission configuration indicator state.

Some examples of the method, network entities, and non-transitory computer-readable medium described herein may further include operations, features, means, or instructions for outputting a fourth indication of a first sub-band configuration for the first sub-band, the first sub-band configuration indicating a reference sub-band, a reference bandwidth part, a reference component carrier, or any combination thereof that includes the one or more parameters, where communicating the one or more messages via the first sub-band may be based on receiving the fourth indication and outputting a fifth indication of a second sub-band configuration for the second sub-band, the second sub-band configuration indicating a reference sub-band, a reference bandwidth part, a reference component carrier, or any combination thereof that includes the one or more second parameters, where communicating the one or more second messages via the second sub-band may be based on receiving the fifth indication.

Some examples of the method, network entities, and non-transitory computer-readable medium described herein may further include operations, features, means, or instructions for outputting a list of sub-bands that utilize the one or more parameters, where communicating the one or more messages via the first sub-band may be based on the first sub-band being included in the list of sub-bands.

Some examples of the method, network entities, and non-transitory computer-readable medium described herein may further include operations, features, means, or instructions for outputting a control message that modifies the one or more parameters, the one or more second parameters, or both, where, after modification, the one or more parameters may be applied to each of the one or more sub-bands and the one or more second parameters may be applied to each of the one or more second sub-bands.

Some examples of the method, network entities, and non-transitory computer-readable medium described herein may further include operations, features, means, or instructions for outputting a control message that modifies the one or more parameters, the one or more second parameters, or both, where the control message includes one or more identifiers for respective sub-bands to which the one or more parameters or the one or more second parameters may be applicable after modification.

Some examples of the method, network entities, and non-transitory computer-readable medium described herein may further include operations, features, means, or instructions for outputting the reference signal in accordance with the reference signal configuration, where a first parameter of the one or more parameters may be derived at least in part from the reference signal configuration and outputting a second reference signal associated with the transmission configuration indicator state in accordance with the reference signal configuration, where a second parameter of the one or more parameters may be derived at least in part from the reference signal configuration.

In some examples of the method, network entities, and non-transitory computer-readable medium described herein, the first parameter may be derived at least in part from a first reference signal identifier for the reference signal and the second parameter may be derived at least in part from a second reference signal identifier for the second reference signal, a sub-band that includes the second reference signal, or both.

In some examples of the method, network entities, and non-transitory computer-readable medium described herein, outputting the second indication may include operations, features, means, or instructions for outputting an indication of a virtual transmission configuration indicator state associated with a set of multiple transmission configuration indicator states including the transmission configuration indicator state, where the one or more parameters may be based on a mapping between the virtual transmission configuration indicator state and the transmission configuration indicator state.

Some examples of the method, network entities, and non-transitory computer-readable medium described herein may further include operations, features, means, or instructions for outputting a third indication of the mapping between the virtual transmission configuration indicator state and the transmission configuration indicator state.

In some examples of the method, network entities, and non-transitory computer-readable medium described herein, the mapping between the virtual transmission configuration indicator state and the transmission configuration indicator state may be based on an identifier of the virtual cell and an identifier of the transmission configuration indicator state.

Some examples of the method, network entities, and non-transitory computer-readable medium described herein may further include operations, features, means, or instructions for outputting a control message that modifies one or more transmission configuration indicator parameters for a set of multiple transmission configuration indicator states associated with the set of multiple sub-bands, where communicating the one or more messages may be based on receiving the control message.

In some examples of the method, network entities, and non-transitory computer-readable medium described herein, the one or more parameters include a first quasi co-location type for the transmission configuration indicator state and a second quasi co-location type for the transmission configuration indicator state and the first quasi co-location type may be associated with a spatial parameter and the second quasi co-location type may be associated with a Doppler shift, a Doppler spread, an average delay, a delay spread, or any combination thereof.

In some examples of the method, network entities, and non-transitory computer-readable medium described herein, the first sub-band may be non-contiguous with at least a second sub-band of the set of multiple sub-bands in a frequency domain.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports transmission configuration indicator (TCI) state management for virtual cells in accordance with one or more aspects of the present disclosure.

FIG. 2 shows an example of a wireless communications system that supports TCI state management for virtual cells in accordance with one or more aspects of the present disclosure.

FIG. 3 shows an example of a signaling diagram that supports TCI state management for virtual cells in accordance with one or more aspects of the present disclosure.

FIG. 4 shows an example of a signaling diagram that supports TCI state management for virtual cells in accordance with one or more aspects of the present disclosure.

FIG. 5 shows an example of a process flow that supports TCI state management for virtual cells in accordance with one or more aspects of the present disclosure.

FIGS. 6 and 7 show block diagrams of devices that support TCI state management for virtual cells in accordance with one or more aspects of the present disclosure.

FIG. 8 shows a block diagram of a communications manager that supports TCI state management for virtual cells in accordance with one or more aspects of the present disclosure.

FIG. 9 shows a diagram of a system including a device that supports TCI state management for virtual cells in accordance with one or more aspects of the present disclosure.

FIGS. 10 and 11 show block diagrams of devices that support TCI state management for virtual cells in accordance with one or more aspects of the present disclosure.

FIG. 12 shows a block diagram of a communications manager that supports TCI state management for virtual cells in accordance with one or more aspects of the present disclosure.

FIG. 13 shows a diagram of a system including a device that supports TCI state management for virtual cells in accordance with one or more aspects of the present disclosure.

FIGS. 14 through 17 show flowcharts illustrating methods that support TCI state management for virtual cells in accordance with one or more aspects of the present disclosure.

### DETAILED DESCRIPTION

A wireless communication system may utilize one or more virtual cells to support flexible spectrum integration (FSI) techniques. For instance, a virtual cell may enable a single scheduling entity (e.g., a hybrid automatic repeat request (HARQ) entity, a network entity) to configure parameters for multiple carriers that are allocated across various contiguous or non-contiguous frequency resources. In some cases, these virtual cell carriers may be referred to as sub-bands (SBs). However, in some cases, implementing FSI techniques may result in ambiguity at the devices (e.g., a user equipment (UE) and a network entity) of the system. For instance, when the UE receives a control message that includes configuration information (e.g., one or more transmission configuration indicator (TCI) state parameters), the UE may not be configured to determine how to apply the information to various SBs across the virtual cell (e.g., to determine which SB(s) the configuration information is applicable to). Moreover, in some cases, a reference signal associated with the configuration information (e.g., reference signals associated with one or more quasi co-location (QCL) types indicated via TCI state parameter(s)) may be transmitted (e.g., located) in one or more of the SBs, and the UE may not be configured to determine (e.g., identify, ascertain) the location (e.g., time resources and frequence resources) of the one or more reference signals, resulting in reduced efficiency, increased latency, and reduced communication quality.

In accordance with aspects described herein, one or more devices of a wireless communication system may support techniques that configure one or more TCI states across one or more SBs of a virtual cell. In some examples, a UE may receive a reference signal configuration that indicates a location of a reference signal (e.g., among other characteristics of the reference signal) associated with a TCI state. Additionally, or alternatively, the UE may receive an indication of one or more TCI state parameters that are applicable to one or more SBs of the virtual cell. In some examples, each SB (e.g., or a subgroup of SBs) may be associated with a respective TCI state (e.g., a respective set of TCI state parameters may be configured per SB). Additionally, or alternatively, the UE may utilize a single TCI state (e.g., a composite TCI state) to derive SB specific TCI parameters. Additionally, or alternatively, the UE may be configured with a virtual TCI state, and the UE may determine the SB specific parameters based on a mapping between the virtual TCI state and the TCI state parameters. Thus, by applying aspects described herein, the UE (e.g., and other devices) may be enabled to efficiently support FSI implementations, which may provide increased data throughput, increased spectral utilization efficiency, and reduced power consumption based on reduced signaling overhead, among other benefits.

Aspects of the disclosure are initially described in the context of wireless communications systems. Aspects of the disclosure are further illustrated by and described with reference to signaling diagrams, process flows, apparatus diagrams, system diagrams, and flowcharts that relate to TCI state management for virtual cells.

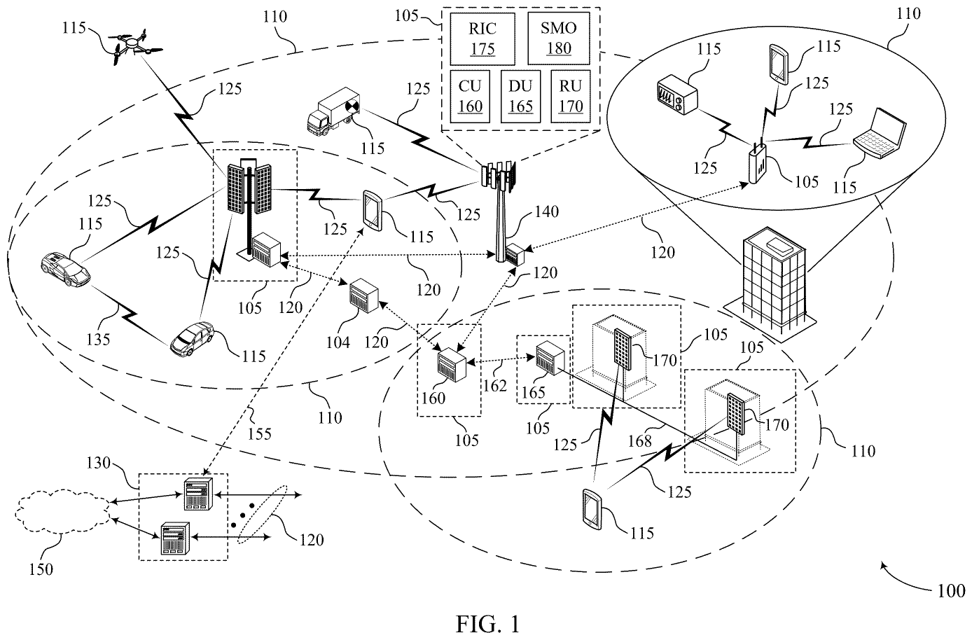

FIG. 1 shows an example of a wireless communications system 100 that supports TCI state management for virtual cells in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support TCI state management for virtual cells as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ}may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may utilize (e.g., implement, allocate) one or more virtual cells for communication with other devices including one or more UEs 115. Such virtual cells may support FSI techniques in which a single scheduling entity (e.g., a HARQ entity, an entity included in or otherwise associated with a network entity 105) configures parameters for multiple carriers that are spread (e.g., allocated, configured) across contiguous or non-contiguous frequency resources. In some cases, these virtual cell carriers may be referred to as “SBs” of the virtual cell. For instance, a same scheduler may transmit control signaling via a first SB that is applicable to the first SB and one or more other SBs of the virtual cell. However, some aspects of the wireless communications system 100 may not (e.g., at least not fully) support such FSI techniques. For instance, a UE 115 may not be configured to determine how to apply TCI state information (e.g., one or more TCI state parameters) to different SBs across the virtual cell. Moreover, the UE 115 may not be able to identify which SB(s) includes a reference signal associated with the TCI state (e.g., reference signals associated with QCL type(s) indicated via the TCI state) for each SB.

In accordance with one or more aspects described herein, the UE 115, network entity 105, and other devices may support techniques to configure TCI states for one or more SBs (e.g., or subgroups of SBs) of a virtual cell. For example, the UE 115 may receive an indication of a reference signal configuration that indicates a reference signal location (e.g., within one or more SBs of the virtual cell) for a TCI state In some examples, the UE 115 may receive an indication of one or more TCI state parameters and may associate (e.g., or derive) SB-specific TCI state parameters based on the indication. Thus, by applying aspects described herein, the wireless communications system 100 and the devices thereof may support various FSI techniques, which may provide increased data rates, increased spectral efficiency, and reduced power consumption to the wireless communications system 100.

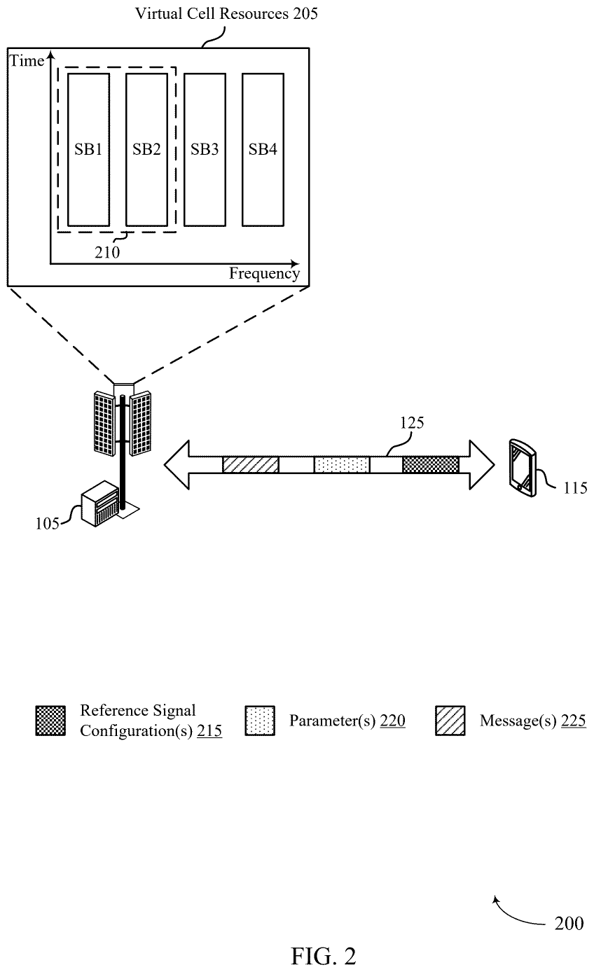

FIG. 2 shows an example of a wireless communications system 200 that supports TCI state management for virtual cells in accordance with one or more aspects of the present disclosure. The wireless communications system 200 may implement or be implemented by aspects of the wireless communications system 100 as described with reference to FIG. 1. For example, the wireless communications system 200 may include a UE 115 and a network entity 105, which may be examples of, or include corresponding devices as described with reference to FIG. 1. The network entity 105 and the UE 115 may communicate (e.g., transmit, receive, obtain, output) via the link(s) 125 (e.g., downlink communication interfaces, uplink communication interfaces, or other communication interfaces). Although a network entity 105 and a UE 115 are shown as example devices of the wireless communications system 200, the techniques herein may be applied by one or more other devices described herein, including with reference to FIG. 1. Moreover, the described techniques may be implemented or supported by any quantity of devices, including by multiple network entities 105, multiple UEs 115, and so on.

In some cases, such as carrier aggregation (e.g., in NR implementations), the wireless communications system 200 (e.g., a sixth generation (6G) system) may use one or more FSI techniques to combine multiple continuous or non-continuous carriers to form a virtual carrier (e.g., a SB), which may increase achievable throughput. Different from other techniques (e.g., carrier aggregation), a virtual carrier may operate as (e.g., be treated as) a single cell from a scheduling or a HARQ perspective. In some cases, such FSI mechanisms may support various improvements over other techniques due to improved bandwidth adaptation latency, reduced overhead, and relatively higher spectrum utilization efficiency, among other factors.

For instance, an FSI virtual cell may include (e.g., be configured with) one or more SBs (e.g., which may not be permitted via carrier aggregation). Such SBs (e.g., component SBs) may be smaller than a threshold bandwidth (e.g., a minimum bandwidth specified for carrier aggregation). Moreover, these SBs may occupy at least a portion of frequency resources (e.g., a frequency gap) between two adjacent carriers (e.g., two component carriers used for carrier aggregation). As such, FSI may enable a more-efficient resource allocation (e.g., combination) of component SBs, and may be an effective candidate for implementation in the wireless communications system 200, particularly in view of non-contiguous spectrum implementations (e.g., for coverage enhancement).

The wireless communications system 200 may support various spectrum management techniques. In a first example (e.g., in a carrier aggregation implementation), the network entity 105 may support one or more component carriers, and communications via each component carrier may be independently controlled (e.g., configured, updated via control messages specific to each CC) by the network entity 105 (e.g., in terms of scheduling or HARQ). As such, decoding complexity (e.g., physical downlink control channel (PDCCH) decoding) may increase proportionally with the quantity of CCs, thus increasing power consumption at the UE 115. In such examples, initial transmissions and subsequent transmissions may be scheduled on a same carrier. That is, transmissions a first component carrier may schedule transmissions for the first component carrier but not for other CCs and vice versa (e.g., such techniques may not support cross component carrier transmission diversity). Moreover, each transport block (TB) may be mapped to a single CC, which may result in reduced code block (CB)-level diversity (e.g., if component carrier bandwidth is relatively small) and inefficient utilization of relatively small and separated portions of the frequency spectrum (e.g., in FDD bands). Additionally, CCs may be added or removed based on application specifications, and bandwidth adaptation via component carrier addition or release may be relatively slow and inefficient.

In a second example (e.g., in an FSI implementation), a single cell (e.g., a virtual cell, a single cell from a scheduling and HARQ perspective) may control multiple carriers. For instance, the network entity 105 may support a virtual cell (e.g., a virtual carrier) that operates as a single scheduling entity, a single HARQ entity, or both. The network entity 105 may utilize a monolithic scheduler developed (e.g., configured) for a specific channel bandwidth and for a virtual carrier of the same bandwidth. Such techniques may support a coordinated downlink scheduling or uplink scheduling, cross-SB scheduling (e.g., with an equivalent quantity of channel control element (CCE) messages or blind decode operations as a single-component carrier message). Moreover, a single BWP may be configured (e.g., defined) and bandwidth adaption (e.g., including baseband and radio frequency adaptation) may be performed by switching a BWP.

For instance, the network entity 105 may implement a virtual cell associated with a set of virtual cell resources 205, which may include one or more SBs (e.g., SB1, SB2, SB3, SB4) used for communications with the UE 115. An SBs may occupy overlapping time resources and different frequency resources than one or more other SBs. Each SB may, in some cases, refer to a physical carrier or a portion of a physical carrier. The SBs may be contiguous with at least one other SBs or non-contiguous with other SBs, and one or more of the SBs may be associated with an active BWP or non-active BWP. For instance, SB1 and SB2 may be associated with a first BWP 210 (e.g., a non-contiguous active BWP, and SB3 and SB4 may be associated with a contiguous non-active BWP or with different BWPs). In some cases, the virtual cell resources 205 may not be associated with a primary cell (PCell) or a secondary cell (SCell) (e.g., may not have PCell/SCell labeling). The virtual cell resources 205 may include an anchor SB (e.g., SB1) that carries downlink control information or uplink control information, and the anchor SB may be switched via configuration (e.g., network configuration) and activation/deactivation indications. In some cases, a numerology alignment across frequency and time may facilitate an integration of resources across the band (e.g., SBs).

In some scenarios, each of the SBs of the virtual cell resources 205 may be associated with (e.g., share) a same beam (e.g., analog beam, a same QCL parameter, a same QCL TypeD reference signal). That is, each SB may share a same spatial dimension for their respective communication beams. Further, each SB may be included within a same band or different bands and each band may be associated with a same frequency range (FR) or a different FR (e.g., FR1, FR2, and so on). In some cases, a same hardware architecture (e.g., including one or more antenna panels) may be shared between different SBs, or different SBs may have different panels or hardware.

However, techniques for beam management in FSI and other implementations (e.g., beam management across multiple SBs of virtual cell resources 205) may not be defined for the UE 115, the network entity 105, and other devices of a wireless communications system 200. For instance, various configuration information (e.g., such as TCI state configuration information) and control information (e.g., for updating the TCI state(s)) may not be defined for the signaling supported by the SBs of the virtual cell resources 205. Further, the location and characteristics of one or more reference signals used by the UE 115 (e.g., for TCI state configuration, for QCL type association) may be ambiguous, and the UE 115 may be unable to receive the reference signal(s). Accordingly, such ambiguity may result in service interruptions, increased latency, and reduced efficiency in the wireless communications system 200.

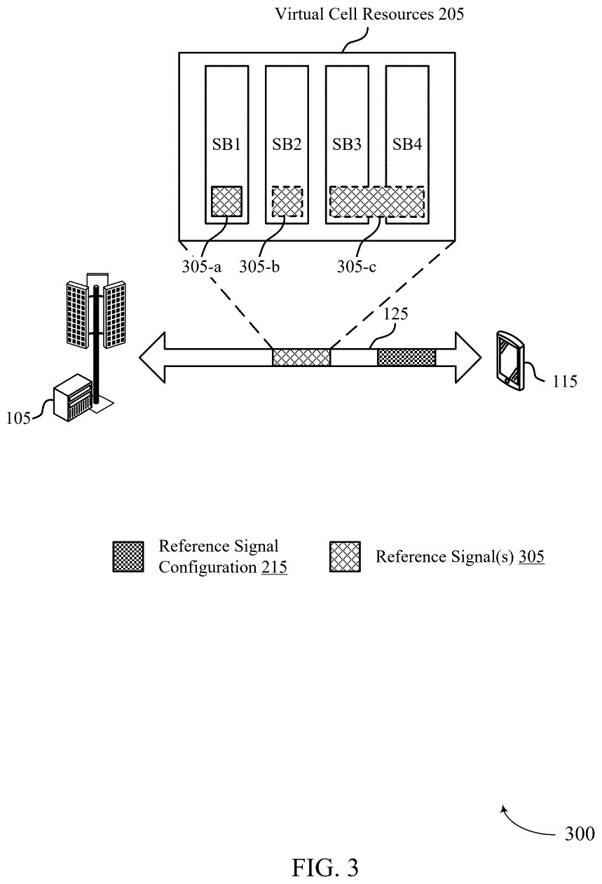

In accordance with various aspects of the present disclosure, the wireless communications system 200 may support signaling and other mechanisms that enable compatibility with FSI implementations and virtual cell implementations. In some examples, the UE 115 may receive (e.g., the network entity 105 may output or transmit) an indication of one or more reference signal configurations 215, which may indicate whether a reference signal is included in one SB of the virtual cell resources 205 or multiple SBs of the virtual cell resources 205. Such aspects of the reference signal configurations 215 may be described in greater detail herein, including with reference to FIG. 3.

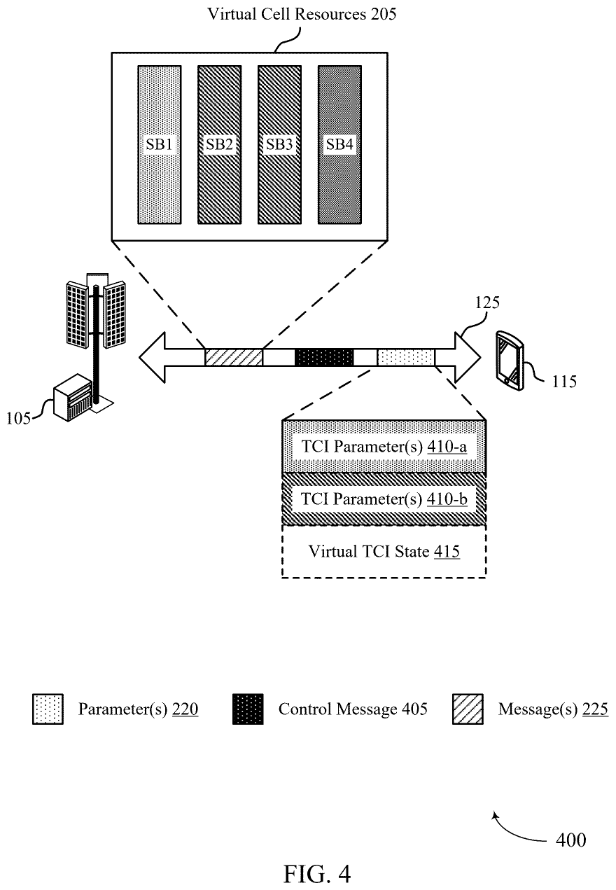

Additionally, or alternatively, the UE 115 may receive (e.g., the network entity 105 may output or transmit) an indication of one or more parameters 220, which may be associated with one or more TCI states applicable to one or more of the SBs. Such aspects of the parameters 220 and SB applicability may be described in greater detail herein, including with reference to FIG. 4. Accordingly, the UE 115 and the network entity 105 may be configured to support FSI techniques and communicate one or more messages 225 via various SBs based on the one or more reference signal configurations 215 and the one or more parameters 220. As such, the wireless communications system 200 may support improved spectral utilization efficiency, improved data throughput, reduced signaling traffic, reduced power consumption and other benefits.

FIG. 3 shows an example of a signaling diagram 300 that supports TCI state management for virtual cells in accordance with one or more aspects of the present disclosure. The signaling diagram 300 may implement or be implemented by aspects of the wireless communications system 100 and the wireless communications system 200 as described with reference to FIGS. 1 and 2. For example, the signaling diagram 300 may include a UE 115 and a network entity 105, which may support communications via various virtual cell resources 205 (e.g., including one or more SBs). Although the non-limiting example of the signaling diagram 300 shows example quantities of UEs 115, network entities 105, virtual cell resources 205 (e.g., SBs), and other components, the described techniques of the signaling diagram 300 may be applicable for greater quantities of components or fewer quantities of components than shown.

In some examples, the UE 115 may receive an indication of a reference signal configuration 215 (e.g., via one or more messages, such as a control message, a synchronization signal block (SSB), a system information message, or some other message) for a virtual cell (e.g., associated with virtual cell resources 205), which may be transmitted by the network entity 105 (e.g., via a link 125). In some examples, the one or more reference signal configurations 215 may be associated with a location of one or more reference signals 305 (e.g., an actual reference signal location), which may be used for specifying TCI configuration for a virtual cell (e.g., an FSI virtual cell, indicating a TCI QCL type configuration at the UE 115). In some examples, the one or more reference signal configurations 215 may indicate whether the one or more reference signals 305 is located in one SB of the virtual cell resources 205 or in two or more SBs of the virtual cell resources 205. For example, the one or more reference signal configurations 215 may indicate that one or more references signals 305 (e.g., reference signal 305-a and/or reference signal 305-b) are located in one SB (e.g., SB1 and/or SB2, respectively, which may be associated with an SSB).

Additionally, or alternatively, the one or more reference signal configurations 215 may indicate that the reference signal 305 is wideband across multiple SBs (e.g., reference signal 305-c across SB3 and SB4, assuming SBs have a same subcarrier spacing (SCS)). In such examples, resource elements (REs) communicated via each SB associated with the wideband reference signal 305-c may be valid (e.g., the reference signal 305-c may be a wideband punctured CSI-RS). In some examples, the wideband reference signal 305-c may be associated with (e.g., may be across) all SBs in the virtual cell to which a same TCI state is applicable. Alternatively, the wideband reference signal 305-c may be associated with (e.g., may be allocated or transmitted across) a subset of SBs (e.g., a SB subgroup) in which a TCI state is applicable (e.g., may be applicable to SB3 and not to SB4). In some examples, an SB subset or subgroup may be configured per BWP. For example, each SB may have an additional field in a configuration message (e.g., the one or more reference signal configurations 215, or some other control message that configures the virtual cell resources 205) indicating a reference SB that belongs to a same SB subgroup. Alternatively, the UE 115 may be configured with a list of SBs (e.g., explicitly signaled or defined) that belong to a same SB subgroup.

Thus, by applying aspects of the signaling diagram 300, the UE 115 may utilize the one or more reference signal configurations 215 and other signaling to determine (e.g., identify, ascertain, configure) a location for one or more reference signals 305 associated with one or more TCI state parameters (e.g., QCL parameters, QCL types) within a set of resources (e.g., time resources and frequency resources) of virtual cell (e.g., virtual cell resources 205). Thus, the UE 115 may communicate (e.g., one or more messages 225) with the network entity 105 via one or more SBs of the virtual cell based on the one or more reference signal configurations 215. Additionally, in some examples, such techniques may be implemented in conjunction with other TCI configuration techniques (e.g., including one or more techniques described with reference to FIG. 4). As such, the UE 115 may be enabled to support TCI state configuration in FSI implementations, including across various SBs of the virtual cell resources 205, which may increase data rates, reduce signaling traffic and overhead, and improve communication quality in a wireless communications system.

FIG. 4 shows an example of a signaling diagram 400 that supports TCI state management for virtual cells in accordance with one or more aspects of the present disclosure. The signaling diagram 400 may implement or be implemented by aspects of the wireless communications system 100, the wireless communications system 200, and the signaling diagram 300 as described with reference to FIG. 1-3. For example, the signaling diagram 400 may include a UE 115 and a network entity 105, which may support communications via various virtual cell resources 205 (e.g., including one or more SBs). Although the non-limiting example of the signaling diagram 400 shows example quantities of UEs 115, network entities 105, virtual cell resources 205 (e.g., SBs), and other components of the signaling diagram 400 are shown for illustrative purposes, the described techniques of the signaling diagram 400 may be applicable for greater quantities of components or fewer quantities of components than shown.

In some examples, the UE 115 may receive (e.g., via one or more messages, via one or more control messages 405) an indication of one or more parameters 220 (e.g., TCI state parameters 410, QCL types(s), indication of a virtual TCI state 415) for a virtual cell (e.g., associated with virtual cell resources 205), which may be transmitted by the network entity 105 (e.g., via a link 125). The parameters 220 may be applicable to one or more SBs of the virtual cell resources 205 and may be associated with a TCI configuration for the one or more SBs (e.g., for FSI implementations). In some examples, the UE 115 may be indicated with multiple TCI states (e.g., multiple actual TCI states) per SB or per SB subgroup (e.g., a subset of SBs of the virtual cell resources 205). That is, the multiple TCI states may be applied to one or more of the SBs of the virtual cell resources 205.

As a non-limiting example, one or more TCI state parameters 410-a may be applicable to SB1, one or more TCI state parameters 410-b may be applicable to SB2 and SB3 (e.g., a SB subgroup), and one or more other TCI state parameters 410 may be applicable to SB4. As such, the UE 115 may communicate with the network entity 105 via SB1 in accordance with the TCI state parameters 410-a, and via SB2 in accordance with the TCI state parameters 410-b. In such examples, each set of TCI state parameters 410 (e.g., each actual TCI state) may be associated with a first QCL type (e.g., a TypeD, or some other QCL type) and a second QCL type (e.g., a TypeA, a TypeB, a TypeC, or some other QCL type) for each SB or SB subgroup. In some examples, a QCL type may indicate a relationship (e.g., an inferred equivalence, or some other association) with a refence signal (e.g., a reference signal 305, which may also be identified via a TCI state parameter 410), and various QCL types may be supported. In some examples, a QCL Type may indicate a relationship with a reference signal in terms of Doppler shift, Doppler spread, average delay, delay spread, a spatial receive parameter, some other parameter, or any combination thereof. For example, a QCL TypeA may be associated with Doppler shift, Doppler spread, average delay, and delay spread, a QCL TypeB may be associated with Doppler shift and Doppler spread, a QCL TypeC may be associated with average delay and Doppler shift, and a QCL TypeD may be associated with a spatial receive parameter.

In some examples, various parameters 220 (e.g., TCI state parameters 410, a TCI pool) may be specific to each SB or each SB subgroup, to each BWP, to each FSI virtual cell, or any combination thereof (e.g., may be configured per SB, per SB subgroup, per BWP, per FSI virtual cell). Additionally, or alternatively, the UE 115 may be configured with an association between a reference signal (e.g., a reference signal 305) and a SB or SB subgroup. For example, each SB may be configured via a field of a control message (e.g., a message that configures the virtual cell resources 205, received from the network entity 105). That is, one or more RRC messages (e.g., or some other type of control messages) may include one or more fields (e.g., fields of an information element) that indicate (e.g., identify, configure, allocate) resources for a given SB and may further indicate other information associated with the given SB. In some examples, the field may indicate a reference SB, a reference, BWP, a reference CC, or any combination thereof, which may provide a set of TCI state parameters (e.g., a TCI pool) for the given SB or SB subgroup associated with the field. Additionally, or alternatively, the UE 115 may receive (e.g., or otherwise determine, via a first SB) a list of SBs that share a same set of TCI state parameters (e.g., which may be configured via one of the SBs, and the list may be different based on the BWP).

In some examples, the UE 115 may receive one or more control messages 405 (e.g., a MAC-control element (MAC-CE) message, a downlink control information (DCI) message, some other control message, or a combination thereof) which may be associated with modifying (e.g., updating) one or more TCI state parameters (e.g., for one or more of the SBs, TCI update signaling). In some examples, the control message 405 (e.g., a single TCI update) may update one or more TCI states (e.g., of the SBs) across the virtual cell. For example, each activated TCI identifier (ID) or TCI ID indicated via a control message 405 may be applied to all intended SBs (e.g., implicitly, based on a rule). The intended SBs may include one or more (e.g., all) of the SBs in a current BWP of the cell. Alternatively, the intended SBs may include a SB subgroup that includes the SB in which the UE 115 receives the control message 405. In some examples, each BWP may have at least one SB list configured (e.g., which may utilize separate TCI update signaling for different virtual cells). In some examples, the control message 405 may activate or deactivate multiple TCI states by specifying a SB ID or a SB subgroup ID. Additionally, or alternatively, the control message 405 (e.g., a DCI based indication) may include multiple TCI state updates (e.g., separate TCI state updates) that are respectively (e.g., individually) applicable to each of the SBs or SB subgroups. Additionally, or alternatively, the control message 405 may include a TCI codepoint that corresponds to a SB or SB subgroup.

In some additional, or alternative, examples, a single TCI state (e.g., a composite TCI state, indicated via the parameters 220) may be used to determine the TCI states for each of the SBs of the 205//. For example, a composite TCI state may include (e.g., identify, indicate) at least a first QCL parameter (e.g., a QCL typeD reference signal) and a second QCL type parameter (e.g., a QCL typeA reference signal, a QCL typeB reference signal, or a QCL typeC reference signal, or some other QCL type reference signal). The UE 115 may derive (e.g., determine, compute, ascertain) corresponding parameters for each SB based on the parameters of the composite TCI state (e.g., which may be the same for each SB or may be different for at least one SB). In some examples, a composite TCI state (e.g., a configured composite TCI pool) may be separately configured for each BWP of each FSI virtual cell (e.g., the composite TCI pool may be configured per BWP per FSI virtual cell).

In some examples, the UE 115 may derive a first QCL parameter (e.g., QCL-TypeD) for each SB (e.g., or each SB subgroup) of the virtual cell resources 205 based on a configuration of the first QCL parameter in the composite TCI state. For example, the UE 115 may derive a QCL parameter based on a reference signal ID (e.g., of a reference signal 305), based on a set of reference signal IDs, based on a virtual RS ID that maps to one or more actual reference signals with a same reference ID or a linked reference signal ID (e.g., based on an ID order for each SB), or any combination thereof. Additionally, or alternatively, the UE 115 may derive a second QCL parameter (e.g., QCL-TypeA, QCL-TypeB, QCL-TypeC) for each SB of the virtual cell resources 205 based on a configuration of the second QCL parameter in the composite TCI state. For example, the UE 115 may derive the second QCL parameter based on a reference signal ID (e.g., a set of reference signal IDs, a virtual reference signal ID), based on a SB or SB subgroup that includes the reference signal, based on a mapping (e.g., explicitly signaled to the UE 115) of a SB ID or a SB subgroup ID (e.g., a mapping between a given SB ID and a QCL type parameter).

Additionally, or alternatively, the UE 115 may receive an indication (e.g., via the parameters 220) of a virtual TCI state 415. The virtual TCI state 415 may be associated with one or more actual TCI states at the UE 115 (e.g., TCI states used for communicating via the SB(s)). Each actual TCI state may include (e.g., be configured with) at least a first QCL type parameter (e.g., TypeD) and a second QCL type parameter (e.g., TypeA, TypeB, TypeC, or some other QCL type) for each SB (e.g., or SB subgroup). In some examples, the virtual TCI state 415 may share a same QCL parameter (e.g., a same QCL TypeD reference signal) for all SBs. In some examples, there may be a separate set of actual TCI state (e.g., an additional TCI pool) configured for each SB or SB subgroup, BWP, and FSI virtual cell (e.g., a separate actual TCI pool configured per SB or SB subgroup, per BWP, per FSI virtual cell). In some examples, the virtual TCI state 415 may be configured via an explicit configuration (e.g., per BWP, per FSI virtual cell), where the virtual TCI state 415 may be mapped to a set of actual TCI states. Additionally, or alternatively, the virtual TCI state 415 may be configured (e.g., implicitly) based on a virtual TCI state ID and an actual TCI state ID (e.g., actual TCI state ID 1 from each SB or SB subgroup may be mapped to virtual TCI state ID 1).

In some examples, such as when utilizing one or more composite TCI states or one or more virtual TCI states 415, the one or more control messages 405 may include a single TCI update command. The TCI updated command may update one or more composite TCI states, one or more virtual TCI states 415, or both. In some examples, a TCI update command may include (or be included in) a TCI activation MAC-CE message, or TCI deactivation MAC-CE message, a TCI update DCI message or a TCI indicating DCI message.

Accordingly, by applying one or more techniques of the signaling diagram 400, the UE 115 may be enabled to support various FSI techniques. For example, by receiving one or more indications of TCI state parameters 410, the UE 115 may support a TCI pool structure that supports the one or more SBs of a virtual cell (e.g., and may be compatible with other wireless communications technologies, such as when a single TCI pool is configured). Additionally, by deriving SB specific TCI state parameters from one or more composite TCI states, the UE 115 may support multiple component carrier TCI updates with a single command (e.g., and may be compatible with a single SB per component carrier operation in cases where one actual TypeD reference signal and one actual TypeA RS are configured in the composite TCI state). Moreover, by utilizing one or more virtual TCI states 415, the UE 115 may support a relatively more flexible mapping between a virtual TCI ID and actual TCI ID(s) (e.g., per SB, TCI IDs may be different). Thus, the UE 115 and the network entity 105 may communicate using increased (e.g., relatively faster) data rates, reduced signaling overhead, reduced power consumption, which may provide improved communication quality in a wireless communications system.

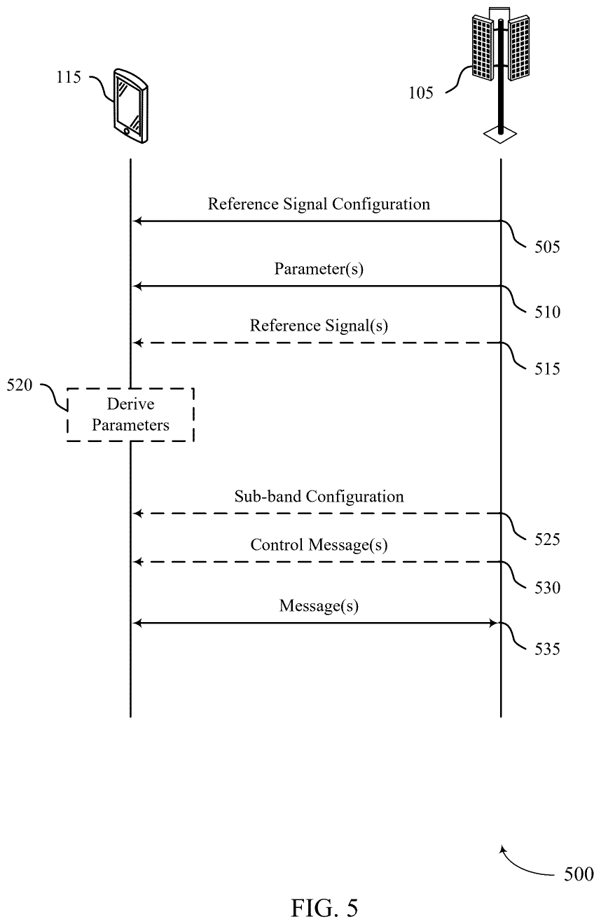

FIG. 5 shows an example of a process flow 500 that supports TCI state management for virtual cells in accordance with one or more aspects of the present disclosure. In some examples, the process flow 500 may implement aspects of the wireless communications system 100, the wireless communications system 200, the signaling diagram 300, and the signaling diagram 400. For example, the process flow 500 may support signaling between a UE 115 and a network entity 105 to enable FSI and virtual cell implementations. The UE 115 and the network entity 105 of the process flow 500 may be examples of corresponding devices herein, including with reference to FIGS. 1 through 4.

In the following description of the process flow 500, the operations between the UE 115 and the network entity 105 may be performed in a different order than the order shown, or other operations may be added or removed from the process flow 500. For example, some operations may also be left out of the process flow 500, or may be performed in different orders or at different times. Further, although some operations or signaling may be shown to occur at different times for discussion purposes, these operations may actually occur at the same time. Although the UE 115 and the network entity 105 are shown performing the operations of the process flow 500, some aspects of some operations may also be performed by one or more other wireless or network devices.

At 505, the UE 115 may receive a first indication of a reference signal configuration (e.g., a one or more reference signal configurations 215) for a virtual cell that includes a set of multiple of SBs (e.g., included in a virtual cell resources 205), which may be output (e.g., transmitted) by the network entity 105. The reference signal configuration may indicate whether a reference signal associated with a TCI state (e.g., a reference signal 305) is included in one SB of the set of SBs or in two or more SBs of the set of SBs. In some examples, a first SB may be non-contiguous with at least a second SB of the set of SBs in a frequency domain. In some examples, the reference signal may be located across two or more SBs, and the two or more SBs may include each SB of the set of SBs that are associated with the TCI state (e.g., with a same TCI state). In some examples, the two or more SBs may include a subgroup of SBs of the set of SBs.

At 510, the UE 115 may receive a second indication of one or more parameters (e.g., parameters 220) for the TCI state, which may be output by the network entity 105. In some examples, the one or more parameters may be applicable to one or more SBs of the set of SBs. In some examples, the one or more parameters may include a first QCL type for the TCI state and a second QCL type for the TCI state. In some examples, the first QCL type may be associated with a spatial parameter and the second QCL type may be associated with a Doppler shift, a Doppler spread, an average delay, a delay spread, or any combination thereof. In some examples, the one or more parameters may be associated with a composite TCI state (e.g., which the UE 115 may use to derive one or more SB specific parameters). In some examples, the parameters may be applicable to one or more SBs. For example, the UE 115 may receive a third indication of one or more second parameters for a second TCI state different than the TCI state. The one or more second parameters may be applicable to one or more second SBs of the set of SBs (e.g., different than the one or more first SBs).

Additionally, or alternatively, the UE 115 may receive an indication of a virtual TCI state (e.g., a virtual TCI state 415, via the parameters or some other control message) associated with a set of TCI states including the TCI state. In some examples, the one or more parameters (e.g., the parameters for each SB) may be based on a mapping between the virtual TCI state and the TCI state. In some examples, the UE 115 may receive an indication of the mapping between the virtual TCI state and the TCI state, or the mapping between the virtual TCI state and the TCI state may be based on an identifier of the virtual cell and an identifier of the TCI state, or both.

At 515, in some examples, the UE 115 may receive one or more reference signals (e.g., reference signals 305, QCL TypeA reference signal, QCL TypeB reference signal, QCL TypeC reference signal, QCL TypeD reference signal) in accordance with the reference signal configuration, which may be output by the network entity 105. In some examples, a first parameter (e.g., QCL TypeD) of the one or more parameters (e.g., parameters 220) may be derived at least in part from the reference signal configuration (e.g., based on being configured with a composite TCI state). The UE 115 may also receive a second reference signal associated with the TCI state in accordance with the reference signal configuration, and a second parameter (e.g., QCL TypeA, QCL TypeB, QCL TypeC) of the one or more parameters may be derived at least in part from the reference signal configuration.

At 520, in some examples, the UE 115 may derive (e.g., obtain, determine, compute) one or more parameters (e.g., TCI state parameters) for each SB based on the reference signal configuration (e.g., and based on a composite TCI state). For example, a first parameter may be derived at least in part from a first reference signal ID for the reference signal, a second parameter may be derived at least in part from a second reference signal ID for the second reference signal, from a SB that includes a reference signal (e.g., the second reference signal), or both.

At 525, in some examples, the UE 115 may receive an indication of a first SB configuration (e.g., via one or more control messages) for the first SB, which may be output by the network entity 105. In some examples, the first SB configuration may indicate a reference SB, a reference BWP, a reference CC, or any combination thereof that includes the one or more parameters. In some examples, the UE 115 may communicate one or more messages via the first SB based on receiving the indication of the first SB configuration. In some examples, the UE 115 may receive an indication of a second SB configuration (e.g., different from the first SB configuration) for the second SB. The second SB configuration may also indicate a reference SB, a reference BWP, a reference CC, or any combination thereof that includes the one or more second parameters. In some examples, the UE 115 may communicate one or more second messages via the second SB based on receiving the indication of the second SB configuration. In some examples, the UE 115 may receive a list of SBs that utilize the one or more parameters, and the UE 115 may communicate one or more messages via the first SB based on the first SB being included in the list of SBs.

At 530, in some examples, the UE 115 may receive a control message (e.g., a control message 405) that modifies (e.g., updates) the one or more parameters, the one or more second parameters, or both. In some examples, after modification, the one or more parameters may be applied to each of the one or more SBs and the one or more second parameters may be applied to each of the one or more second SBs. Additionally, or alternatively, the control message may include one or more IDs for respective SBs to which the one or more parameters or the one or more second parameters are applicable after modification (e.g., the updated parameters). Additionally, or alternatively, the UE 115 may receive a control message that modifies one or more TCI parameters for a set of multiple TCI states associated with the set of SBs.

At 535, the UE 115 and the network entity 105 may communicate one or more messages (e.g., control channel messages, shared channel messages, or other messages) via a first SB of the plurality of SBs of the virtual cell based on the UE 115 receiving (e.g., and the network entity 105 outputting) the one or more reference signals and in accordance with the one or more parameters. In some examples, the UE 115 and the network entity 105 may also communicate one or more second messages via the second SB of the set of SBs of the virtual cell in accordance with the second TCI state.

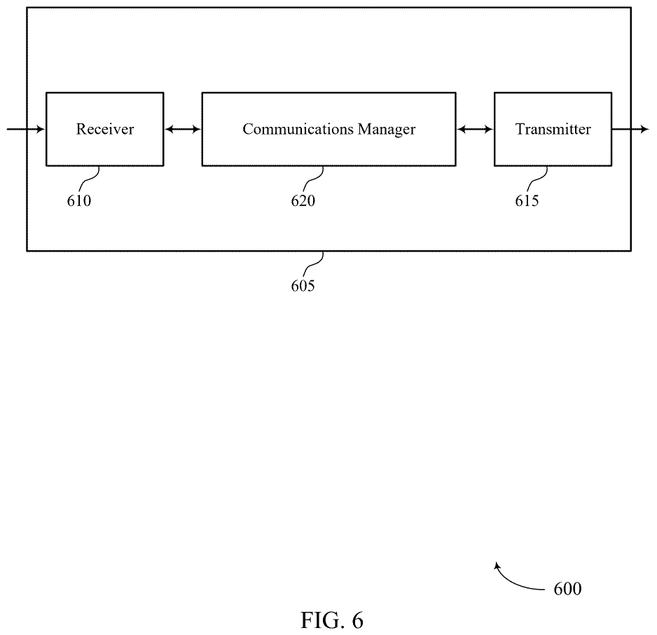

FIG. 6 shows a block diagram 600 of a device 605 that supports TCI state management for virtual cells in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to TCI state management for virtual cells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TCI state management for virtual cells). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of TCI state management for virtual cells as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The communications manager 620 is capable of, configured to, or operable to support a means for receiving a second indication of one or more parameters for the TCI state, where the one or more parameters are applicable to one or more sub-bands of the set of multiple sub-bands. The communications manager 620 is capable of, configured to, or operable to support a means for communicating one or more messages via a first sub-band of the set of multiple sub-bands of the virtual cell based on receiving the reference signal and in accordance with the one or more parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other benefits.

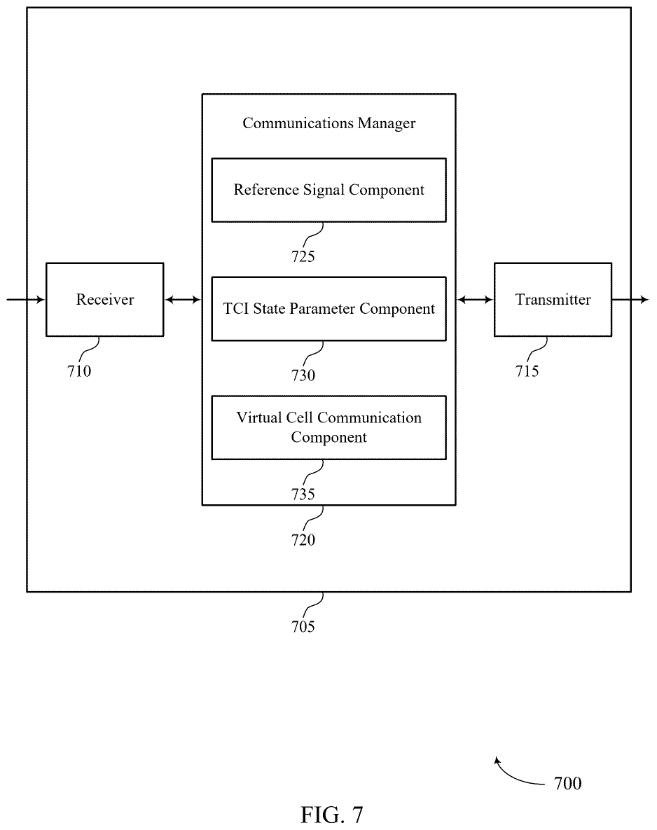

FIG. 7 shows a block diagram 700 of a device 705 that supports TCI state management for virtual cells in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to TCI state management for virtual cells). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to TCI state management for virtual cells). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of TCI state management for virtual cells as described herein. For example, the communications manager 720 may include a reference signal component 725, a TCI state parameter component 730, a virtual cell communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The reference signal component 725 is capable of, configured to, or operable to support a means for receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The TCI state parameter component 730 is capable of, configured to, or operable to support a means for receiving a second indication of one or more parameters for the TCI state, where the one or more parameters are applicable to one or more sub-bands of the set of multiple sub-bands. The virtual cell communication component 735 is capable of, configured to, or operable to support a means for communicating one or more messages via a first sub-band of the set of multiple sub-bands of the virtual cell based on receiving the reference signal and in accordance with the one or more parameters.

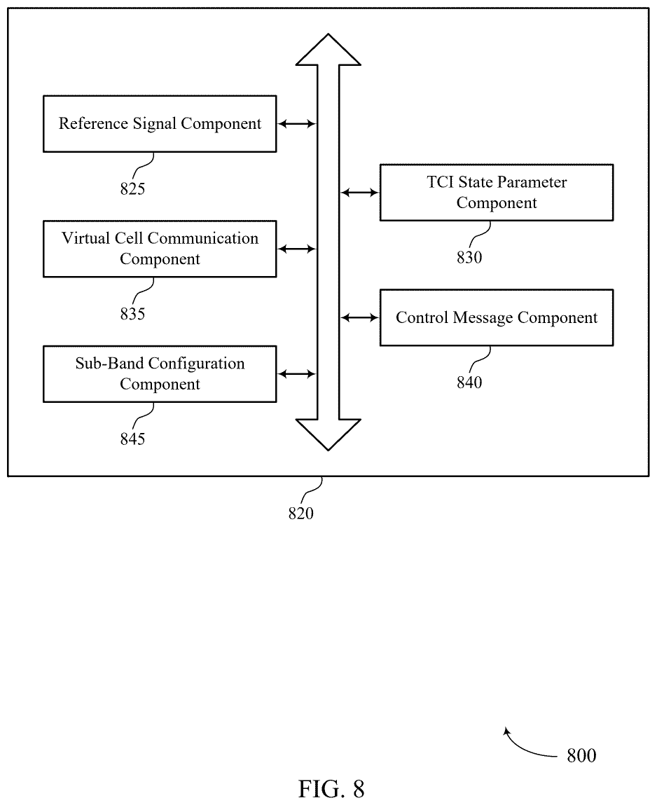

FIG. 8 shows a block diagram 800 of a communications manager 820 that supports TCI state management for virtual cells in accordance with one or more aspects of the present disclosure. The communications manager 820 may be an example of aspects of a communications manager 620, a communications manager 720, or both, as described herein. The communications manager 820, or various components thereof, may be an example of means for performing various aspects of TCI state management for virtual cells as described herein. For example, the communications manager 820 may include a reference signal component 825, a TCI state parameter component 830, a virtual cell communication component 835, a control message component 840, a sub-band configuration component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The reference signal component 825 is capable of, configured to, or operable to support a means for receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The TCI state parameter component 830 is capable of, configured to, or operable to support a means for receiving a second indication of one or more parameters for the TCI state, where the one or more parameters are applicable to one or more sub-bands of the set of multiple sub-bands. The virtual cell communication component 835 is capable of, configured to, or operable to support a means for communicating one or more messages via a first sub-band of the set of multiple sub-bands of the virtual cell based on receiving the reference signal and in accordance with the one or more parameters.

In some examples, the reference signal is located across the two or more sub-bands. In some examples, the two or more sub-bands include each sub-band of the set of multiple sub-bands that are associated with the TCI state.

In some examples, the reference signal is included in the two or more sub-bands. In some examples, a first set of sub-bands of the set of multiple sub-bands including the first sub-band is associated with the TCI state. In some examples, the two or more sub-bands include a subgroup of sub-bands of the first set of sub-bands.

In some examples, the TCI state parameter component 830 is capable of, configured to, or operable to support a means for receiving a third indication of one or more second parameters for a second TCI state different than the TCI state, where the one or more second parameters are applicable to one or more second sub-bands of the set of multiple sub-bands. In some examples, the virtual cell communication component 835 is capable of, configured to, or operable to support a means for communicating one or more second messages via a second sub-band of the set of multiple sub-bands of the virtual cell in accordance with the second TCI state.

In some examples, the sub-band configuration component 845 is capable of, configured to, or operable to support a means for receiving a fourth indication of a first sub-band configuration for the first sub-band, the first sub-band configuration indicating a reference sub-band, a reference bandwidth part, a reference component carrier, or any combination thereof that includes the one or more parameters, where communicating the one or more messages via the first sub-band is based on receiving the fourth indication. In some examples, the sub-band configuration component 845 is capable of, configured to, or operable to support a means for receiving a fifth indication of a second sub-band configuration for the second sub-band, the second sub-band configuration indicating a reference sub-band, a reference bandwidth part, a reference component carrier, or any combination thereof that includes the one or more second parameters, where communicating the one or more second messages via the second sub-band is based on receiving the fifth indication.

In some examples, the sub-band configuration component 845 is capable of, configured to, or operable to support a means for receiving a list of sub-bands that utilize the one or more parameters, where communicating the one or more messages via the first sub-band is based on the first sub-band being included in the list of sub-bands.

In some examples, the control message component 840 is capable of, configured to, or operable to support a means for receiving a control message that modifies the one or more parameters, the one or more second parameters, or both, where, after modification, the one or more parameters are applied to each of the one or more sub-bands and the one or more second parameters are applied to each of the one or more second sub-bands.

In some examples, the control message component 840 is capable of, configured to, or operable to support a means for receiving a control message that modifies the one or more parameters, the one or more second parameters, or both, where the control message includes one or more identifiers for respective sub-bands to which the one or more parameters or the one or more second parameters are applicable after modification.

In some examples, the reference signal component 825 is capable of, configured to, or operable to support a means for receiving the reference signal in accordance with the reference signal configuration, where a first parameter of the one or more parameters is derived at least in part from the reference signal configuration. In some examples, the reference signal component 825 is capable of, configured to, or operable to support a means for receiving a second reference signal associated with the TCI state in accordance with the reference signal configuration, where a second parameter of the one or more parameters is derived at least in part from the reference signal configuration.

In some examples, the first parameter is derived at least in part from a first reference signal identifier for the reference signal. In some examples, the second parameter is derived at least in part from a second reference signal identifier for the second reference signal, a sub-band that includes the second reference signal, or both.

In some examples, to support receiving the second indication, the TCI state parameter component 830 is capable of, configured to, or operable to support a means for receiving an indication of a virtual TCI state associated with a set of multiple TCI states including the TCI state, where the one or more parameters are based on a mapping between the virtual TCI state and the TCI state.

In some examples, the TCI state parameter component 830 is capable of, configured to, or operable to support a means for receiving a third indication of the mapping between the virtual TCI state and the TCI state.

In some examples, the mapping between the virtual TCI state and the TCI state is based on an identifier of the virtual cell and an identifier of the TCI state.

In some examples, the control message component 840 is capable of, configured to, or operable to support a means for receiving a control message that modifies one or more TCI parameters for a set of multiple TCI states associated with the set of multiple sub-bands, where communicating the one or more messages is based on receiving the control message.

In some examples, the one or more parameters include a first QCL type for the TCI state and a second QCL type for the TCI state. In some examples, the first QCL type is associated with a spatial parameter and the second QCL type is associated with a Doppler shift, a Doppler spread, an average delay, a delay spread, or any combination thereof.

In some examples, the first sub-band is non-contiguous with at least a second sub-band of the set of multiple sub-bands in a frequency domain.

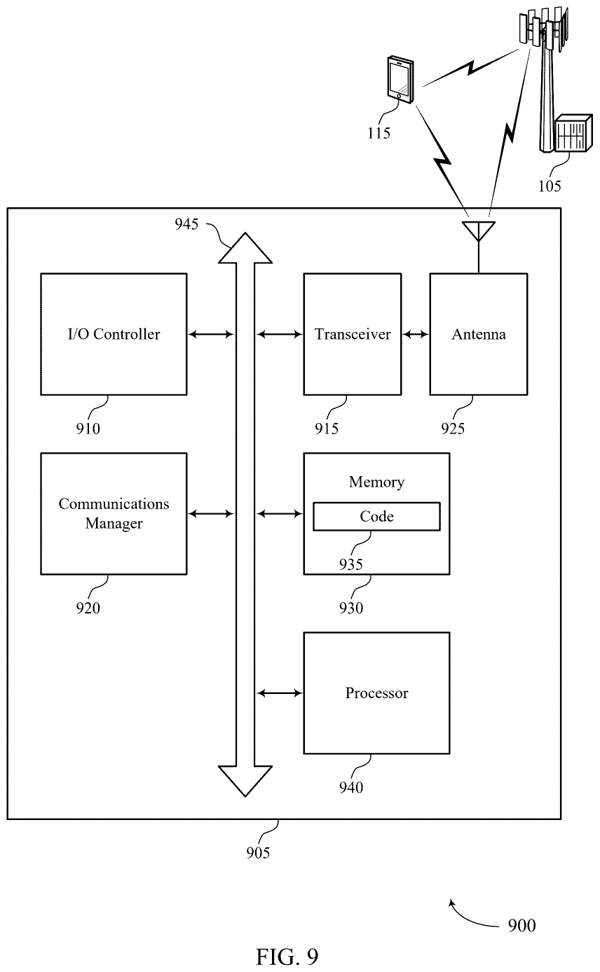

FIG. 9 shows a diagram of a system 900 including a device 905 that supports TCI state management for virtual cells in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting TCI state management for virtual cells). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The communications manager 920 is capable of, configured to, or operable to support a means for receiving a second indication of one or more parameters for the TCI state, where the one or more parameters are applicable to one or more sub-bands of the set of multiple sub-bands. The communications manager 920 is capable of, configured to, or operable to support a means for communicating one or more messages via a first sub-band of the set of multiple sub-bands of the virtual cell based on receiving the reference signal and in accordance with the one or more parameters.

By including or configuring the communications manager 920 in accordance with examples as described herein, the device 905 may support techniques for reduced latency, improved user experience related to reduced processing, reduced power consumption, more efficient utilization of communication resources, improved coordination between devices, and improved utilization of processing capability, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of TCI state management for virtual cells as described herein, or the at least one processor 940 and the at least one memory 930 may be otherwise configured to, individually or collectively, perform or support such operations.

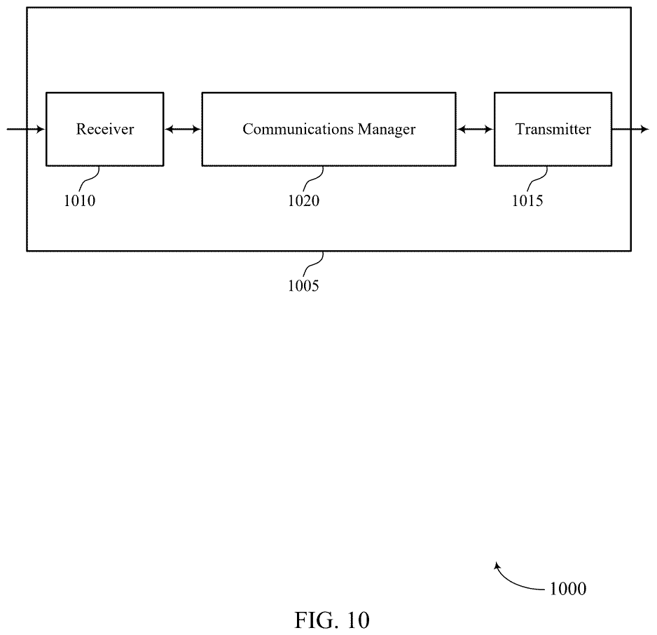

FIG. 10 shows a block diagram 1000 of a device 1005 that supports TCI state management for virtual cells in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of TCI state management for virtual cells as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The communications manager 1020 is capable of, configured to, or operable to support a means for outputting a second indication of one or more parameters for the TCI state, where the one or more parameters are applicable to one or more sub-bands of the set of multiple sub-bands. The communications manager 1020 is capable of, configured to, or operable to support a means for communicating one or more messages via a first sub-band of the set of multiple sub-bands of the virtual cell based on receiving the reference signal and in accordance with the one or more parameters.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources, among other benefits.

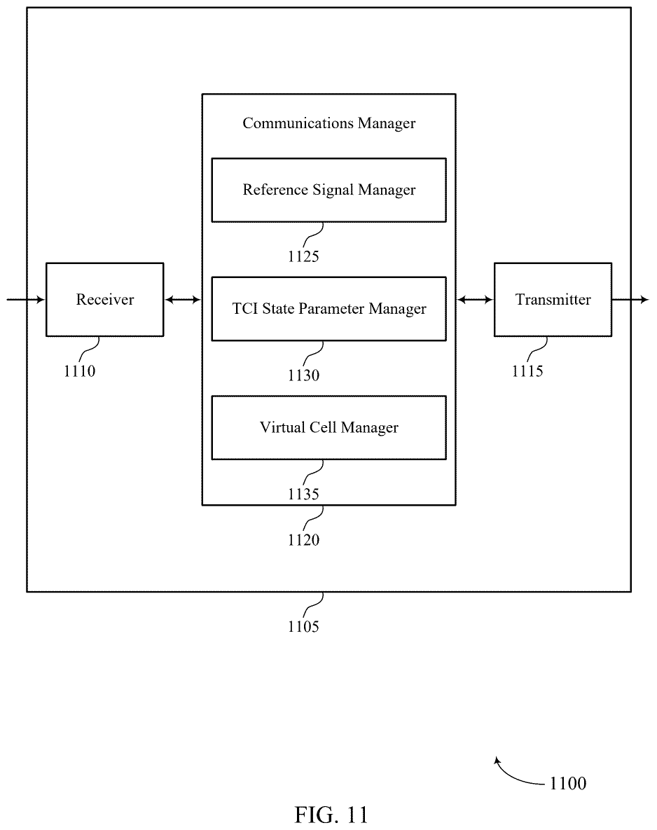

FIG. 11 shows a block diagram 1100 of a device 1105 that supports TCI state management for virtual cells in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of TCI state management for virtual cells as described herein. For example, the communications manager 1120 may include a reference signal manager 1125, a TCI state parameter manager 1130, a virtual cell manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The reference signal manager 1125 is capable of, configured to, or operable to support a means for outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The TCI state parameter manager 1130 is capable of, configured to, or operable to support a means for outputting a second indication of one or more parameters for the TCI state, where the one or more parameters are applicable to one or more sub-bands of the set of multiple sub-bands. The virtual cell manager 1135 is capable of, configured to, or operable to support a means for communicating one or more messages via a first sub-band of the set of multiple sub-bands of the virtual cell based on receiving the reference signal and in accordance with the one or more parameters.

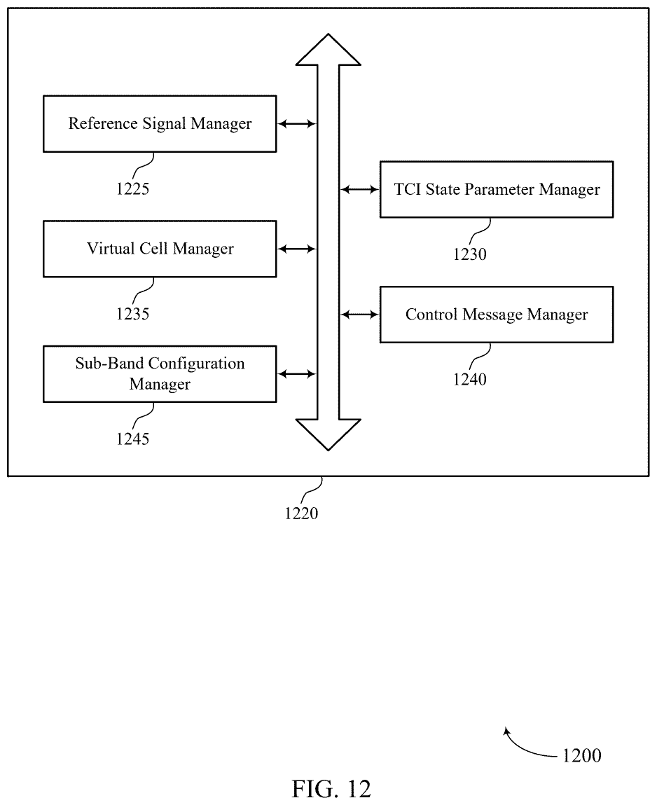

FIG. 12 shows a block diagram 1200 of a communications manager 1220 that supports TCI state management for virtual cells in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of TCI state management for virtual cells as described herein. For example, the communications manager 1220 may include a reference signal manager 1225, a TCI state parameter manager 1230, a virtual cell manager 1235, a control message manager 1240, a sub-band configuration manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The reference signal manager 1225 is capable of, configured to, or operable to support a means for outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The TCI state parameter manager 1230 is capable of, configured to, or operable to support a means for outputting a second indication of one or more parameters for the TCI state, where the one or more parameters are applicable to one or more sub-bands of the set of multiple sub-bands. The virtual cell manager 1235 is capable of, configured to, or operable to support a means for communicating one or more messages via a first sub-band of the set of multiple sub-bands of the virtual cell based on receiving the reference signal and in accordance with the one or more parameters.

In some examples, the reference signal is located across the two or more sub-bands. In some examples, the two or more sub-bands include each sub-band of the set of multiple sub-bands that are associated with the TCI state.

In some examples, the reference signal is included in the two or more sub-bands. In some examples, a first set of sub-bands of the set of multiple sub-bands including the first sub-band is associated with the TCI state. In some examples, the two or more sub-bands include a subgroup of sub-bands of the first set of sub-bands.

In some examples, the TCI state parameter manager 1230 is capable of, configured to, or operable to support a means for outputting a third indication of one or more second parameters for a second TCI state different than the TCI state, where the one or more second parameters are applicable to one or more second sub-bands of the set of multiple sub-bands. In some examples, the virtual cell manager 1235 is capable of, configured to, or operable to support a means for communicating one or more second messages via a second sub-band of the set of multiple sub-bands of the virtual cell in accordance with the second TCI state.

In some examples, the sub-band configuration manager 1245 is capable of, configured to, or operable to support a means for outputting a fourth indication of a first sub-band configuration for the first sub-band, the first sub-band configuration indicating a reference sub-band, a reference bandwidth part, a reference component carrier, or any combination thereof that includes the one or more parameters, where communicating the one or more messages via the first sub-band is based on receiving the fourth indication. In some examples, the sub-band configuration manager 1245 is capable of, configured to, or operable to support a means for outputting a fifth indication of a second sub-band configuration for the second sub-band, the second sub-band configuration indicating a reference sub-band, a reference bandwidth part, a reference component carrier, or any combination thereof that includes the one or more second parameters, where communicating the one or more second messages via the second sub-band is based on receiving the fifth indication.

In some examples, the sub-band configuration manager 1245 is capable of, configured to, or operable to support a means for outputting a list of sub-bands that utilize the one or more parameters, where communicating the one or more messages via the first sub-band is based on the first sub-band being included in the list of sub-bands.

In some examples, the control message manager 1240 is capable of, configured to, or operable to support a means for outputting a control message that modifies the one or more parameters, the one or more second parameters, or both, where, after modification, the one or more parameters are applied to each of the one or more sub-bands and the one or more second parameters are applied to each of the one or more second sub-bands.

In some examples, the control message manager 1240 is capable of, configured to, or operable to support a means for outputting a control message that modifies the one or more parameters, the one or more second parameters, or both, where the control message includes one or more identifiers for respective sub-bands to which the one or more parameters or the one or more second parameters are applicable after modification.

In some examples, the reference signal manager 1225 is capable of, configured to, or operable to support a means for outputting the reference signal in accordance with the reference signal configuration, where a first parameter of the one or more parameters is derived at least in part from the reference signal configuration. In some examples, the reference signal manager 1225 is capable of, configured to, or operable to support a means for outputting a second reference signal associated with the TCI state in accordance with the reference signal configuration, where a second parameter of the one or more parameters is derived at least in part from the reference signal configuration.

In some examples, the first parameter is derived at least in part from a first reference signal identifier for the reference signal. In some examples, the second parameter is derived at least in part from a second reference signal identifier for the second reference signal, a sub-band that includes the second reference signal, or both.

In some examples, to support outputting the second indication, the TCI state parameter manager 1230 is capable of, configured to, or operable to support a means for outputting an indication of a virtual TCI state associated with a set of multiple TCI states including the TCI state, where the one or more parameters are based on a mapping between the virtual TCI state and the TCI state.

In some examples, the TCI state parameter manager 1230 is capable of, configured to, or operable to support a means for outputting a third indication of the mapping between the virtual TCI state and the TCI state.

In some examples, the mapping between the virtual TCI state and the TCI state is based on an identifier of the virtual cell and an identifier of the TCI state.

In some examples, the control message manager 1240 is capable of, configured to, or operable to support a means for outputting a control message that modifies one or more TCI parameters for a set of multiple TCI states associated with the set of multiple sub-bands, where communicating the one or more messages is based on receiving the control message.

In some examples, the one or more parameters include a first QCL type for the TCI state and a second QCL type for the TCI state. In some examples, the first QCL type is associated with a spatial parameter and the second QCL type is associated with a Doppler shift, a Doppler spread, an average delay, a delay spread, or any combination thereof.

In some examples, the first sub-band is non-contiguous with at least a second sub-band of the set of multiple sub-bands in a frequency domain.

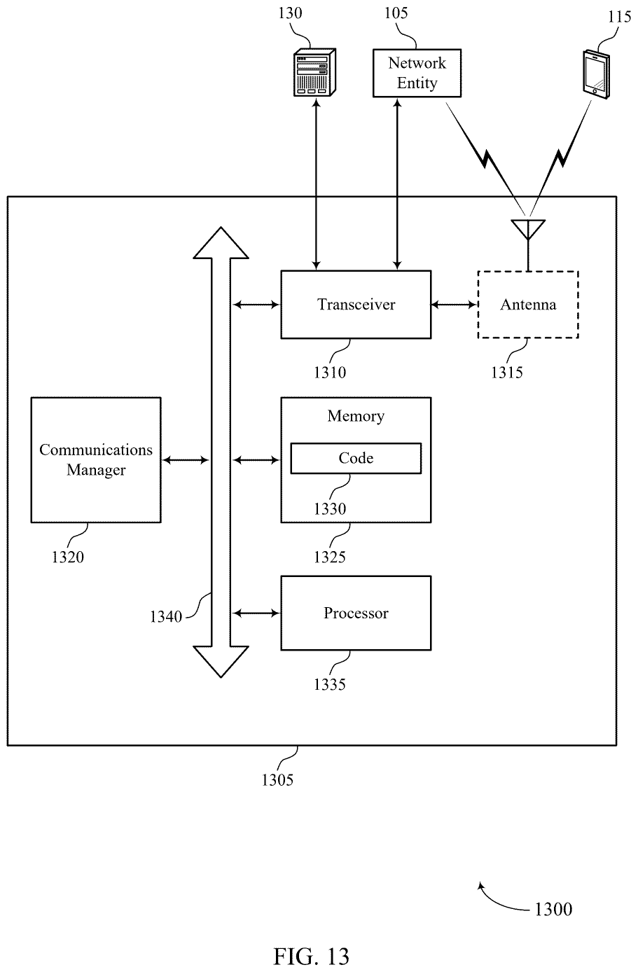

FIG. 13 shows a diagram of a system 1300 including a device 1305 that supports TCI state management for virtual cells in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting TCI state management for virtual cells). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 13..05 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The communications manager 1320 is capable of, configured to, or operable to support a means for outputting a second indication of one or more parameters for the TCI state, where the one or more parameters are applicable to one or more sub-bands of the set of multiple sub-bands. The communications manager 1320 is capable of, configured to, or operable to support a means for communicating one or more messages via a first sub-band of the set of multiple sub-bands of the virtual cell based on receiving the reference signal and in accordance with the one or more parameters.

By including or configuring the communications manager 1320 in accordance with examples as described herein, the device 1305 may support techniques for reduced latency, improved user experience related to reduced processing, reduced power consumption, more efficient utilization of communication resources, improved coordination between devices, and improved utilization of processing capability, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of TCI state management for virtual cells as described herein, or the at least one processor 1335 and the at least one memory 1325 may be otherwise configured to, individually or collectively, perform or support such operations.

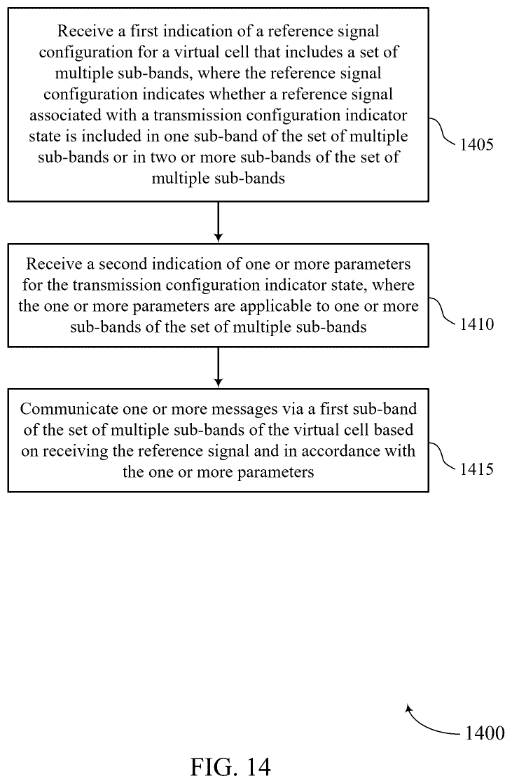

FIG. 14 shows a flowchart illustrating a method 1400 that supports TCI state management for virtual cells in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The operations of 1405 may be performed in accordance with examples as disclosed herein. In some examples, aspects of the operations of 1405 may be performed by a reference signal component 825 as described with reference to FIG. 8.

At 1410, the method may include receiving a second indication of one or more parameters for the TCI state, where the one or more parameters are applicable to one or more sub-bands of the set of multiple sub-bands. The operations of 1410 may be performed in accordance with examples as disclosed herein. In some examples, aspects of the operations of 1410 may be performed by a TCI state parameter component 830 as described with reference to FIG. 8.

At 1415, the method may include communicating one or more messages via a first sub-band of the set of multiple sub-bands of the virtual cell based on receiving the reference signal and in accordance with the one or more parameters. The operations of 1415 may be performed in accordance with examples as disclosed herein. In some examples, aspects of the operations of 1415 may be performed by a virtual cell communication component 835 as described with reference to FIG. 8.

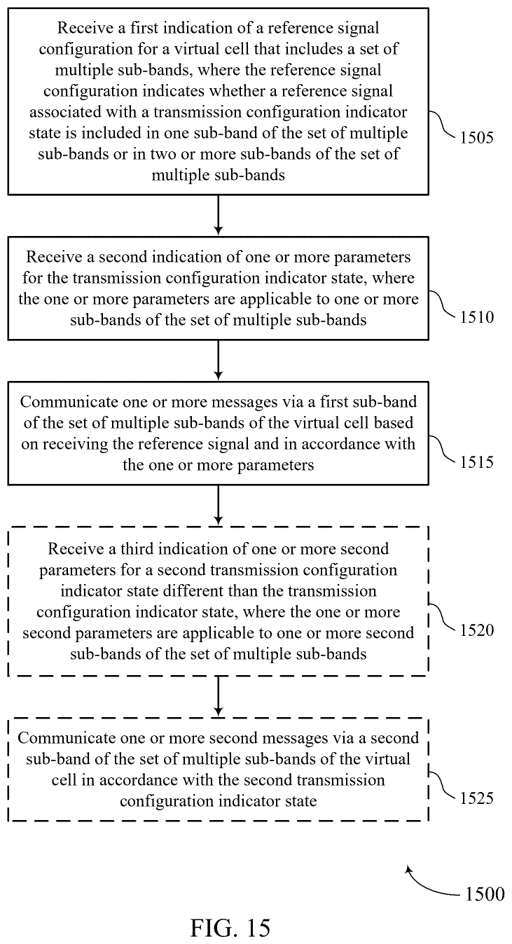

FIG. 15 shows a flowchart illustrating a method 1500 that supports TCI state management for virtual cells in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The operations of 1505 may be performed in accordance with examples as disclosed herein. In some examples, aspects of the operations of 1505 may be performed by a reference signal component 825 as described with reference to FIG. 8.

At 1510, the method may include receiving a second indication of one or more parameters for the TCI state, where the one or more parameters are applicable to one or more sub-bands of the set of multiple sub-bands. The operations of 1510 may be performed in accordance with examples as disclosed herein. In some examples, aspects of the operations of 1510 may be performed by a TCI state parameter component 830 as described with reference to FIG. 8.

At 1515, the method may include communicating one or more messages via a first sub-band of the set of multiple sub-bands of the virtual cell based on receiving the reference signal and in accordance with the one or more parameters. The operations of 1515 may be performed in accordance with examples as disclosed herein. In some examples, aspects of the operations of 1515 may be performed by a virtual cell communication component 835 as described with reference to FIG. 8.

At 1520, in some examples, the method may include receiving a third indication of one or more second parameters for a second TCI state different than the TCI state, where the one or more second parameters are applicable to one or more second sub-bands of the set of multiple sub-bands. The operations of 1520 may be performed in accordance with examples as disclosed herein. In some examples, aspects of the operations of 1520 may be performed by a TCI state parameter component 830 as described with reference to FIG. 8.

At 1525, in some examples, the method may include communicating one or more second messages via a second sub-band of the set of multiple sub-bands of the virtual cell in accordance with the second TCI state. The operations of 1525 may be performed in accordance with examples as disclosed herein. In some examples, aspects of the operations of 1525 may be performed by a virtual cell communication component 835 as described with reference to FIG. 8.

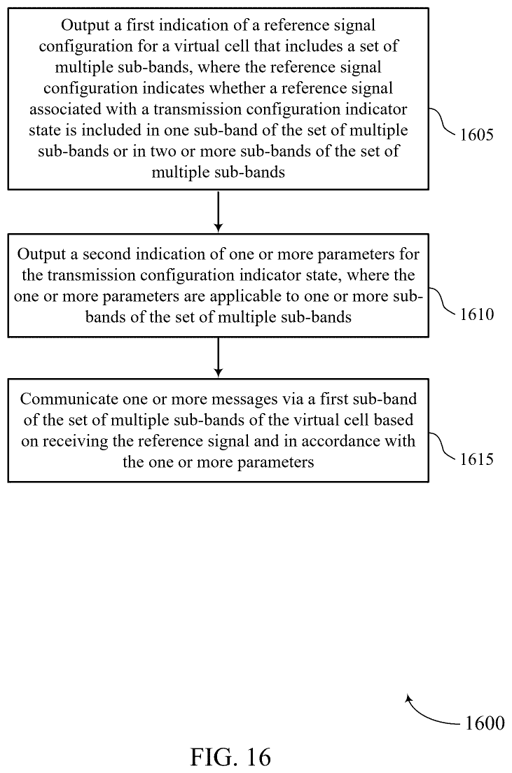

FIG. 16 shows a flowchart illustrating a method 1600 that supports TCI state management for virtual cells in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The operations of 1605 may be performed in accordance with examples as disclosed herein. In some examples, aspects of the operations of 1605 may be performed by a reference signal manager 1225 as described with reference to FIG. 12.

At 1610, the method may include outputting a second indication of one or more parameters for the TCI state, where the one or more parameters are applicable to one or more sub-bands of the set of multiple sub-bands. The operations of 1610 may be performed in accordance with examples as disclosed herein. In some examples, aspects of the operations of 1610 may be performed by a TCI state parameter manager 1230 as described with reference to FIG. 12.

At 1615, the method may include communicating one or more messages via a first sub-band of the set of multiple sub-bands of the virtual cell based on receiving the reference signal and in accordance with the one or more parameters. The operations of 1615 may be performed in accordance with examples as disclosed herein. In some examples, aspects of the operations of 1615 may be performed by a virtual cell manager 1235 as described with reference to FIG. 12.

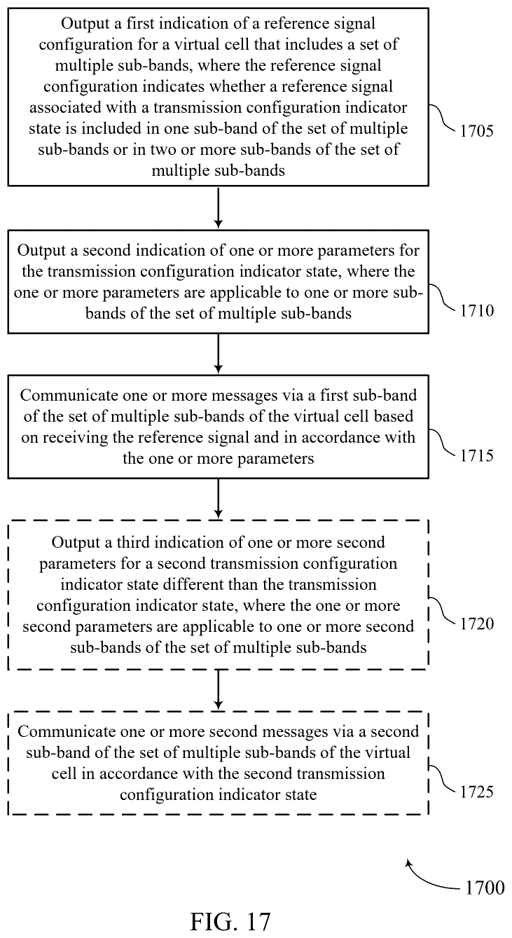

FIG. 17 shows a flowchart illustrating a method 1700 that supports TCI state management for virtual cells in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a first indication of a reference signal configuration for a virtual cell that includes a set of multiple sub-bands, where the reference signal configuration indicates whether a reference signal associated with a TCI state is included in one sub-band of the set of multiple sub-bands or in two or more sub-bands of the set of multiple sub-bands. The operations of 1705 may be performed in accordance with examples as disclosed herein. In some examples, aspects of the operations of 1705 may be performed by a reference signal manager 1225 as described with reference to FIG. 12.

At 1710, the method may include outputting a second indication of one or more parameters for the TCI state, where the one or more parameters are applicable to one or more sub-bands of the set of multiple sub-bands. The operations of 1710 may be performed in accordance with examples as disclosed herein. In some examples, aspects of the operations of 1710 may be performed by a TCI state parameter manager 1230 as described with reference to FIG. 12.

At 1715, the method may include communicating one or more messages via a first sub-band of the set of multiple sub-bands of the virtual cell based on receiving the reference signal and in accordance with the one or more parameters. The operations of 1715 may be performed in accordance with examples as disclosed herein. In some examples, aspects of the operations of 1715 may be performed by a virtual cell manager 1235 as described with reference to FIG. 12.

At 1720, in some examples, the method may include outputting a third indication of one or more second parameters for a second TCI state different than the TCI state, where the one or more second parameters are applicable to one or more second sub-bands of the set of multiple sub-bands. The operations of 1720 may be performed in accordance with examples as disclosed herein. In some examples, aspects of the operations of 1720 may be performed by a TCI state parameter manager 1230 as described with reference to FIG. 12.

At 1725, in some examples, the method may include communicating one or more second messages via a second sub-band of the set of multiple sub-bands of the virtual cell in accordance with the second TCI state. The operations of 1725 may be performed in accordance with examples as disclosed herein. In some examples, aspects of the operations of 1725 may be performed by a virtual cell manager 1235 as described with reference to FIG. 12.

The following provides an overview of aspects of the present disclosure:
Aspect 1: A method for wireless communications by a UE, comprising: receiving a first indication of a reference signal configuration for a virtual cell that comprises a plurality of SBs, wherein the reference signal configuration indicates whether a reference signal associated with a TCI state is included in one SB of the plurality of SBs or in two or more SBs of the plurality of SBs; receiving a second indication of one or more parameters for the TCI state, wherein the one or more parameters are applicable to one or more SBs of the plurality of SBs; and communicating one or more messages via a first SB of the plurality of SBs of the virtual cell based at least in part on receiving the reference signal and in accordance with the one or more parameters.
Aspect 2: The method of aspect 1, wherein the reference signal is located across the two or more SBs, and the two or more SBs comprise each SB of the plurality of SBs that are associated with the TCI state.
Aspect 3: The method of aspect 1, wherein the reference signal is included in the two or more SBs, a first set of SBs of the plurality of SBs including the first SB is associated with the TCI state, and the two or more SBs comprise a subgroup of SBs of the first set of SBs.
Aspect 4: The method of any of aspects 1 through 3, further comprising: receiving a third indication of one or more second parameters for a second TCI state different than the TCI state, wherein the one or more second parameters are applicable to one or more second SBs of the plurality of SBs; and communicating one or more second messages via a second SB of the plurality of SBs of the virtual cell in accordance with the second TCI state.
Aspect 5: The method of aspect 4, further comprising: receiving a fourth indication of a first SB configuration for the first SB, the first SB configuration indicating a reference SB, a reference bandwidth part, a reference component carrier, or any combination thereof that comprises the one or more parameters, wherein communicating the one or more messages via the first SB is based at least in part on receiving the fourth indication; and receiving a fifth indication of a second SB configuration for the second SB, the second SB configuration indicating a reference SB, a reference bandwidth part, a reference component carrier, or any combination thereof that comprises the one or more second parameters, wherein communicating the one or more second messages via the second SB is based at least in part on receiving the fifth indication.
Aspect 6: The method of aspect 4, further comprising: receiving a list of SBs that utilize the one or more parameters, wherein communicating the one or more messages via the first SB is based at least in part on the first SB being included in the list of SBs.
Aspect 7: The method of any of aspects 4 through 6, further comprising: receiving a control message that modifies the one or more parameters, the one or more second parameters, or both, wherein, after modification, the one or more parameters are applied to each of the one or more SBs and the one or more second parameters are applied to each of the one or more second SBs.
Aspect 8: The method of any of aspects 4 through 7, further comprising: receiving a control message that modifies the one or more parameters, the one or more second parameters, or both, wherein the control message comprises one or more identifiers for respective SBs to which the one or more parameters or the one or more second parameters are applicable after modification.
Aspect 9: The method of any of aspects 1 through 3, further comprising: receiving the reference signal in accordance with the reference signal configuration, wherein a first parameter of the one or more parameters is derived at least in part from the reference signal configuration; and receiving a second reference signal associated with the TCI state in accordance with the reference signal configuration, wherein a second parameter of the one or more parameters is derived at least in part from the reference signal configuration.
Aspect 10: The method of aspect 9, wherein the first parameter is derived at least in part from a first reference signal identifier for the reference signal, and the second parameter is derived at least in part from a second reference signal identifier for the second reference signal, a SB that includes the second reference signal, or both.
Aspect 11: The method of any of aspects 1 through 3, wherein receiving the second indication comprises: receiving an indication of a virtual TCI state associated with a plurality of TCI states including the TCI state, wherein the one or more parameters are based at least in part on a mapping between the virtual TCI state and the TCI state.
Aspect 12: The method of aspect 11, further comprising: receiving a third indication of the mapping between the virtual TCI state and the TCI state.
Aspect 13: The method of any of aspects 11 through 12, wherein the mapping between the virtual TCI state and the TCI state is based at least in part on an identifier of the virtual cell and an identifier of the TCI state.
Aspect 14: The method of any of aspects 1 through 13, further comprising: receiving a control message that modifies one or more TCI parameters for a plurality of TCI states associated with the plurality of SBs, wherein communicating the one or more messages is based at least in part on receiving the control message.
Aspect 15: The method of any of aspects 1 through 14, wherein the one or more parameters include a first QCL type for the TCI state and a second QCL type for the TCI state, the first QCL type is associated with a spatial parameter and the second QCL type is associated with a Doppler shift, a Doppler spread, an average delay, a delay spread, or any combination thereof.
Aspect 16: The method of any of aspects 1 through 15, wherein the first SB is non-contiguous with at least a second SB of the plurality of SBs in a frequency domain.
Aspect 17: A method for wireless communications by a network entity, comprising: outputting a first indication of a reference signal configuration for a virtual cell that comprises a plurality of SBs, wherein the reference signal configuration indicates whether a reference signal associated with a TCI state is included in one SB of the plurality of SBs or in two or more SBs of the plurality of SBs; outputting a second indication of one or more parameters for the TCI state, wherein the one or more parameters are applicable to one or more SBs of the plurality of SBs; and communicating one or more messages via a first SB of the plurality of SBs of the virtual cell based at least in part on receiving the reference signal and in accordance with the one or more parameters.
Aspect 18: The method of aspect 17, wherein the reference signal is located across the two or more SBs, and the two or more SBs comprise each SB of the plurality of SBs that are associated with the TCI state.
Aspect 19: The method of aspect 17, wherein the reference signal is included in the two or more SBs, a first set of SBs of the plurality of SBs including the first SB is associated with the TCI state, and the two or more SBs comprise a subgroup of SBs of the first set of SBs.
Aspect 20: The method of any of aspects 17 through 19, further comprising: outputting a third indication of one or more second parameters for a second TCI state different than the TCI state, wherein the one or more second parameters are applicable to one or more second SBs of the plurality of SBs; and communicating one or more second messages via a second SB of the plurality of SBs of the virtual cell in accordance with the second TCI state.
Aspect 21: The method of aspect 20, further comprising: outputting a fourth indication of a first SB configuration for the first SB, the first SB configuration indicating a reference SB, a reference bandwidth part, a reference component carrier, or any combination thereof that comprises the one or more parameters, wherein communicating the one or more messages via the first SB is based at least in part on receiving the fourth indication; and outputting a fifth indication of a second SB configuration for the second SB, the second SB configuration indicating a reference SB, a reference bandwidth part, a reference component carrier, or any combination thereof that comprises the one or more second parameters, wherein communicating the one or more second messages via the second SB is based at least in part on receiving the fifth indication.
Aspect 22: The method of aspect 20, further comprising: outputting a list of SBs that utilize the one or more parameters, wherein communicating the one or more messages via the first SB is based at least in part on the first SB being included in the list of SBs.
Aspect 23: The method of any of aspects 20 through 22, further comprising: outputting a control message that modifies the one or more parameters, the one or more second parameters, or both, wherein, after modification, the one or more parameters are applied to each of the one or more SBs and the one or more second parameters are applied to each of the one or more second SBs.
Aspect 24: The method of any of aspects 20 through 23, further comprising: outputting a control message that modifies the one or more parameters, the one or more second parameters, or both, wherein the control message comprises one or more identifiers for respective SBs to which the one or more parameters or the one or more second parameters are applicable after modification.
Aspect 25: The method of any of aspects 17 through 19, further comprising: outputting the reference signal in accordance with the reference signal configuration, wherein a first parameter of the one or more parameters is derived at least in part from the reference signal configuration; and outputting a second reference signal associated with the TCI state in accordance with the reference signal configuration, wherein a second parameter of the one or more parameters is derived at least in part from the reference signal configuration.
Aspect 26: The method of aspect 25, wherein the first parameter is derived at least in part from a first reference signal identifier for the reference signal, and the second parameter is derived at least in part from a second reference signal identifier for the second reference signal, a SB that includes the second reference signal, or both.
Aspect 27: The method of any of aspects 17 through 19, wherein outputting the second indication comprises: outputting an indication of a virtual TCI state associated with a plurality of TCI states including the TCI state, wherein the one or more parameters are based at least in part on a mapping between the virtual TCI state and the TCI state.
Aspect 28: The method of aspect 27, further comprising: outputting a third indication of the mapping between the virtual TCI state and the TCI state.
Aspect 29: The method of any of aspects 27 through 28, wherein the mapping between the virtual TCI state and the TCI state is based at least in part on an identifier of the virtual cell and an identifier of the TCI state.
Aspect 30: The method of any of aspects 17 through 29, further comprising: outputting a control message that modifies one or more TCI parameters for a plurality of TCI states associated with the plurality of SBs, wherein communicating the one or more messages is based at least in part on receiving the control message.
Aspect 31: The method of any of aspects 17 through 30, wherein the one or more parameters include a first QCL type for the TCI state and a second QCL type for the TCI state, the first QCL type is associated with a spatial parameter and the second QCL type is associated with a Doppler shift, a Doppler spread, an average delay, a delay spread, or any combination thereof.
Aspect 32: The method of any of aspects 17 through 31, wherein the first SB is non-contiguous with at least a second SB of the plurality of SBs in a frequency domain.
Aspect 33: A UE for wireless communications, comprising one or more memories storing processor-executable code, and one or more processors coupled with the one or more memories and individually or collectively operable to execute the code to cause the UE to perform a method of any of aspects 1 through 16.
Aspect 34: A UE for wireless communications, comprising at least one means for performing a method of any of aspects 1 through 16.
Aspect 35: A non-transitory computer-readable medium storing code for wireless communications, the code comprising instructions executable by one or more processors to perform a method of any of aspects 1 through 16.
Aspect 36: A network entity for wireless communications, comprising one or more memories storing processor-executable code, and one or more processors coupled with the one or more memories and individually or collectively operable to execute the code to cause the network entity to perform a method of any of aspects 17 through 32.
Aspect 37: A network entity for wireless communications, comprising at least one means for performing a method of any of aspects 17 through 32.
Aspect 38: A non-transitory computer-readable medium storing code for wireless communications, the code comprising instructions executable by one or more processors to perform a method of any of aspects 17 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first indication of a reference signal configuration for a virtual cell that comprises a plurality of sub-bands, wherein the reference signal configuration indicates whether a reference signal associated with a transmission configuration indicator state is included in one sub-band of the plurality of sub-bands or in two or more sub-bands of the plurality of sub-bands;
receive a second indication of one or more parameters for the transmission configuration indicator state, wherein the one or more parameters are applicable to one or more sub-bands of the plurality of sub-bands; and
communicate one or more messages via a first sub-band of the plurality of sub-bands of the virtual cell based at least in part on receiving the reference signal and in accordance with the one or more parameters.

2. The UE of claim 1, wherein:
the reference signal is located across the two or more sub-bands, and
the two or more sub-bands comprise each sub-band of the plurality of sub-bands that are associated with the transmission configuration indicator state.

3. The UE of claim 1, wherein:
the reference signal is included in the two or more sub-bands,
a first set of sub-bands of the plurality of sub-bands including the first sub-band is associated with the transmission configuration indicator state, and
the two or more sub-bands comprise a subgroup of sub-bands of the first set of sub-bands.

4. The UE of claim 1, wherein the one or more processors are individually or collectively further operable to execute the code to cause the UE to:
receive a third indication of one or more second parameters for a second transmission configuration indicator state different than the transmission configuration indicator state, wherein the one or more second parameters are applicable to one or more second sub-bands of the plurality of sub-bands; and
communicate one or more second messages via a second sub-band of the plurality of sub-bands of the virtual cell in accordance with the second transmission configuration indicator state.

5. The UE of claim 4, wherein the one or more processors are individually or collectively further operable to execute the code to cause the UE to:
receive a fourth indication of a first sub-band configuration for the first sub-band, the first sub-band configuration indicating a reference sub-band, a reference bandwidth part, a reference component carrier, or any combination thereof that comprises the one or more parameters, wherein communicating the one or more messages via the first sub-band is based at least in part on receiving the fourth indication; and
receive a fifth indication of a second sub-band configuration for the second sub-band, the second sub-band configuration indicating a reference sub-band, a reference bandwidth part, a reference component carrier, or any combination thereof that comprises the one or more second parameters, wherein communicating the one or more second messages via the second sub-band is based at least in part on receiving the fifth indication.

6. The UE of claim 4, wherein the one or more processors are individually or collectively further operable to execute the code to cause the UE to:
receive a list of sub-bands that utilize the one or more parameters, wherein communicating the one or more messages via the first sub-band is based at least in part on the first sub-band being included in the list of sub-bands.

7. The UE of claim 4, wherein the one or more processors are individually or collectively further operable to execute the code to cause the UE to:
receive a control message that modifies the one or more parameters, the one or more second parameters, or both, wherein, after modification, the one or more parameters are applied to each of the one or more sub-bands and the one or more second parameters are applied to each of the one or more second sub-bands.

8. The UE of claim 4, wherein the one or more processors are individually or collectively further operable to execute the code to cause the UE to:
receive a control message that modifies the one or more parameters, the one or more second parameters, or both, wherein the control message comprises one or more identifiers for respective sub-bands to which the one or more parameters or the one or more second parameters are applicable after modification.

9. The UE of claim 1, wherein the one or more processors are individually or collectively further operable to execute the code to cause the UE to:
receive the reference signal in accordance with the reference signal configuration, wherein a first parameter of the one or more parameters is derived at least in part from the reference signal configuration; and
receive a second reference signal associated with the transmission configuration indicator state in accordance with the reference signal configuration, wherein a second parameter of the one or more parameters is derived at least in part from the reference signal configuration.

10. The UE of claim 9, wherein:
the first parameter is derived at least in part from a first reference signal identifier for the reference signal, and
the second parameter is derived at least in part from a second reference signal identifier for the second reference signal, a sub-band that includes the second reference signal, or both.

11. The UE of claim 1, wherein, to receive the second indication, the one or more processors are individually or collectively operable to execute the code to cause the UE to:
receive an indication of a virtual transmission configuration indicator state associated with a plurality of transmission configuration indicator states including the transmission configuration indicator state, wherein the one or more parameters are based at least in part on a mapping between the virtual transmission configuration indicator state and the transmission configuration indicator state.

12. The UE of claim 11, wherein the one or more processors are individually or collectively further operable to execute the code to cause the UE to:
receive a third indication of the mapping between the virtual transmission configuration indicator state and the transmission configuration indicator state.

13. The UE of claim 11, wherein the mapping between the virtual transmission configuration indicator state and the transmission configuration indicator state is based at least in part on an identifier of the virtual cell and an identifier of the transmission configuration indicator state.

14. The UE of claim 1, wherein the one or more processors are individually or collectively further operable to execute the code to cause the UE to:
receive a control message that modifies one or more transmission configuration indicator parameters for a plurality of transmission configuration indicator states associated with the plurality of sub-bands, wherein communicating the one or more messages is based at least in part on receiving the control message.

15. The UE of claim 1, wherein:
the one or more parameters include a first quasi co-location type for the transmission configuration indicator state and a second quasi co-location type for the transmission configuration indicator state; and
the first quasi co-location type is associated with a spatial parameter and the second quasi co-location type is associated with a Doppler shift, a Doppler spread, an average delay, a delay spread, or any combination thereof.

16. The UE of claim 1, wherein the first sub-band is non-contiguous with at least a second sub-band of the plurality of sub-bands in a frequency domain.

17. A network entity, comprising:
one or more memories storing processor-executable code; and
one or more processors coupled with the one or more memories and individually or collectively operable to execute the code to cause the network entity to:
output a first indication of a reference signal configuration for a virtual cell that comprises a plurality of sub-bands, wherein the reference signal configuration indicates whether a reference signal associated with a transmission configuration indicator state is included in one sub-band of the plurality of sub-bands or in two or more sub-bands of the plurality of sub-bands;
output a second indication of one or more parameters for the transmission configuration indicator state, wherein the one or more parameters are applicable to one or more sub-bands of the plurality of sub-bands; and
communicate one or more messages via a first sub-band of the plurality of sub-bands of the virtual cell based at least in part on receiving the reference signal and in accordance with the one or more parameters.

18. The network entity of claim 17, wherein:
the reference signal is located across the two or more sub-bands, and
the two or more sub-bands comprise each sub-band of the plurality of sub-bands that are associated with the transmission configuration indicator state.

19. The network entity of claim 17, wherein:
the reference signal is included in the two or more sub-bands,
a first set of sub-bands of the plurality of sub-bands including the first sub-band is associated with the transmission configuration indicator state, and
the two or more sub-bands comprise a subgroup of sub-bands of the first set of sub-bands.

20. The network entity of claim 17, wherein the one or more processors are individually or collectively further operable to execute the code to cause the network entity to:
output a third indication of one or more second parameters for a second transmission configuration indicator state different than the transmission configuration indicator state, wherein the one or more second parameters are applicable to one or more second sub-bands of the plurality of sub-bands; and
communicate one or more second messages via a second sub-band of the plurality of sub-bands of the virtual cell in accordance with the second transmission configuration indicator state.

21. The network entity of claim 20, wherein the one or more processors are individually or collectively further operable to execute the code to cause the network entity to:
output a fourth indication of a first sub-band configuration for the first sub-band, the first sub-band configuration indicating a reference sub-band, a reference bandwidth part, a reference component carrier, or any combination thereof that comprises the one or more parameters, wherein communicating the one or more messages via the first sub-band is based at least in part on receiving the fourth indication; and
output a fifth indication of a second sub-band configuration for the second sub-band, the second sub-band configuration indicating a reference sub-band, a reference bandwidth part, a reference component carrier, or any combination thereof that comprises the one or more second parameters, wherein communicating the one or more second messages via the second sub-band is based at least in part on receiving the fifth indication.

22. The network entity of claim 20, wherein the one or more processors are individually or collectively further operable to execute the code to cause the network entity to:
output a list of sub-bands that utilize the one or more parameters, wherein communicating the one or more messages via the first sub-band is based at least in part on the first sub-band being included in the list of sub-bands.

23. The network entity of claim 20, wherein the one or more processors are individually or collectively further operable to execute the code to cause the network entity to:
output a control message that modifies the one or more parameters, the one or more second parameters, or both, wherein, after modification, the one or more parameters are applied to each of the one or more sub-bands and the one or more second parameters are applied to each of the one or more second sub-bands.

24. The network entity of claim 20, wherein the one or more processors are individually or collectively further operable to execute the code to cause the network entity to:
output a control message that modifies the one or more parameters, the one or more second parameters, or both, wherein the control message comprises one or more identifiers for respective sub-bands to which the one or more parameters or the one or more second parameters are applicable after modification.

25. The network entity of claim 17, wherein the one or more processors are individually or collectively further operable to execute the code to cause the network entity to:
output the reference signal in accordance with the reference signal configuration, wherein a first parameter of the one or more parameters is derived at least in part from the reference signal configuration; and
output a second reference signal associated with the transmission configuration indicator state in accordance with the reference signal configuration, wherein a second parameter of the one or more parameters is derived at least in part from the reference signal configuration.

26. The network entity of claim 25, wherein:
the first parameter is derived at least in part from a first reference signal identifier for the reference signal, and
the second parameter is derived at least in part from a second reference signal identifier for the second reference signal, a sub-band that includes the second reference signal, or both.

27. A method for wireless communications by a user equipment (UE), comprising:
receiving a first indication of a reference signal configuration for a virtual cell that comprises a plurality of sub-bands, wherein the reference signal configuration indicates whether a reference signal associated with a transmission configuration indicator state is included in one sub-band of the plurality of sub-bands or in two or more sub-bands of the plurality of sub-bands;
receiving a second indication of one or more parameters for the transmission configuration indicator state, wherein the one or more parameters are applicable to one or more sub-bands of the plurality of sub-bands; and
communicating one or more messages via a first sub-band of the plurality of sub-bands of the virtual cell based at least in part on receiving the reference signal and in accordance with the one or more parameters.

28. The method of claim 27, wherein:
the reference signal is located across the two or more sub-bands; and
the two or more sub-bands comprise each sub-band of the plurality of sub-bands that are associated with the transmission configuration indicator state.

29. A method for wireless communications by a network entity, comprising:
outputting a first indication of a reference signal configuration for a virtual cell that comprises a plurality of sub-bands, wherein the reference signal configuration indicates whether a reference signal associated with a transmission configuration indicator state is included in one sub-band of the plurality of sub-bands or in two or more sub-bands of the plurality of sub-bands;
outputting a second indication of one or more parameters for the transmission configuration indicator state, wherein the one or more parameters are applicable to one or more sub-bands of the plurality of sub-bands; and
communicating one or more messages via a first sub-band of the plurality of sub-bands of the virtual cell based at least in part on receiving the reference signal and in accordance with the one or more parameters.

30. The method of claim 29, wherein:
the reference signal is located across the two or more sub-bands; and
the two or more sub-bands comprise each sub-band of the plurality of sub-bands that are associated with the transmission configuration indicator state.
